(19) United States
(12) Patent Application Publication
(10) Pub. No.: US 2016/0308731 A1
(43) Pub. Date: Oct. 20, 2016

(54) ANALYSIS METHOD, COMPUTER READABLE RECORDING MEDIUM, AND ANALYSIS APPARATUS

(71) Applicant: FUJITSU LIMITED, Kawasaki-shi (JP)

(72) Inventors: Koichiro Yamashita, Hachioji (JP); Takahisa Suzuki, Yokohama (JP); Hiromasa Yamauchi, Kawasaki (JP); Toshiya Otomo, Kawasaki (JP)

(73) Assignee: FUJITSU LIMITED, Kawasaki-shi (JP)

(21) Appl. No.: 15/195,389

(22) Filed: Jun. 28, 2016

Related U.S. Application Data
(63) Continuation of application No. PCT/JP2014/050189, filed on Jan. 9, 2014.

(51) Int. Cl. H04L 12/24; H04L 29/08; H04L 12/26

(52) U.S. Cl. CPC H04L 41/147; H04L 41/06; H04L 43/0817; H04L 43/50; H04L 43/04; H04L 67/12

(57) ABSTRACT

An analysis method includes detecting, by a computer, a malfunctioning node count of nodes malfunctioning among plural nodes in a period during operation of a system configured to realize a function even when a portion of nodes malfunction among the plural nodes; and calculating, by the computer and based on the detected malfunctioning node count and the period, a count of nodes that malfunction per unit time after the period.

### CROSS REFERENCE TO RELATED APPLICATIONS

This application is a continuation application of International Application PCT/JP2014/050189, filed on Jan. 9, 2014 and designating the U.S., the entire contents of which are incorporated herein by reference.

### FIELD

Embodiments discussed herein relate to an analysis method, a computer product, and an analysis apparatus.

### BACKGROUND

Conventionally, there are techniques of analyzing the state of a system to detect failures in the system. For example, a related technique protects the operating system of a sensor node by creating an application failure domain in the data memory address space of the sensor node. Another technique uses command/response property information as load data of a transmission path that performs input during actual operation, when prediction is performed in advance by a network simulator (for example, refer to Published Japanese-Translation of PCT Application, Publication No. 2009-522664 and Japanese Laid-Open Patent Publication No. H7-58760).

### SUMMARY

According to an aspect of an embodiment, an analysis method includes detecting, by a computer, a malfunctioning node count of nodes malfunctioning among plural nodes in a period during operation of a system configured to realize a function even when a portion of nodes malfunction among the plural nodes; and calculating, by the computer and based on the detected malfunctioning node count and the period, a count of nodes that malfunction per unit time after the period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1(A) and 1(B) are diagrams of an operation example of a system according to a first embodiment;

FIG. 2 is a diagram depicting an example of connection of a sensor network system according to the first embodiment;

FIG. 3 is a block diagram of an example of hardware configuration of a server;

FIG. 4 is a block diagram of an example of hardware configuration of a data aggregating apparatus;

FIG. 5 is a block diagram of an example of hardware configuration of a node;

FIG. 6 is a block diagram of an example of a functional configuration of the server according to the first embodiment;

FIG. 7 is a diagram depicting scenarios from development of the sensor network system until operation;

FIG. 8 is a diagram depicting an example of the contents of an acceptable product ratio DB;

FIG. 9 is a diagram depicting an example of an acceptable product ratio over time for individually inspected products and for sampling inspected products;

FIG. 10 is a diagram depictinq temporally the acceptable product ratio during operation when sampling inspected products are dispersed with redundancy;

FIGS. 11(A), 11(B), and 11(C) are diagrams depicting an example of determining whether additional nodes are to be dispersed and the number of nodes to be added;

FIG. 12 is a diagram depicting an example of additional node dispersion;

FIG. 13 is a flowchart of an example of a procedure of a sensor network system operation process by a node;

FIG. 14 is a flowchart of an example of a procedure of an analysis process;

FIG. 15 is a diagram depicting an example of connection of the sensor network system according to a second embodiment;

FIG. 16 is a block diagram of an example of a functional configuration of a simulator;

FIG. 17 is a diagram depicting an example of simulation in a case where nodes that malfunction are randomly changed;

FIGS. 18(A) and 18(B) are diagrams of an example of changing a communication path built by the nodes (part 1);

FIGS. 19(A) and 19(B) are diagrams of an example of changing a communication path built by nodes (part 2);

FIGS. 20(A) and 20(B) are diagrams of an example pf changing a communication path built by nodes (part 3);

FIG. 21 is a diagram of an example of changing a communication path built by nodes (part 4); and

FIG. 22 is a flowchart of an example of a procedure of a function maintenance index output process.

### DESCRIPTION OF THE INVENTION

Embodiments of an analysis method, an analysis program, and an analysis apparatus of the present disclosure will be described in detail with reference to the accompanying drawings.

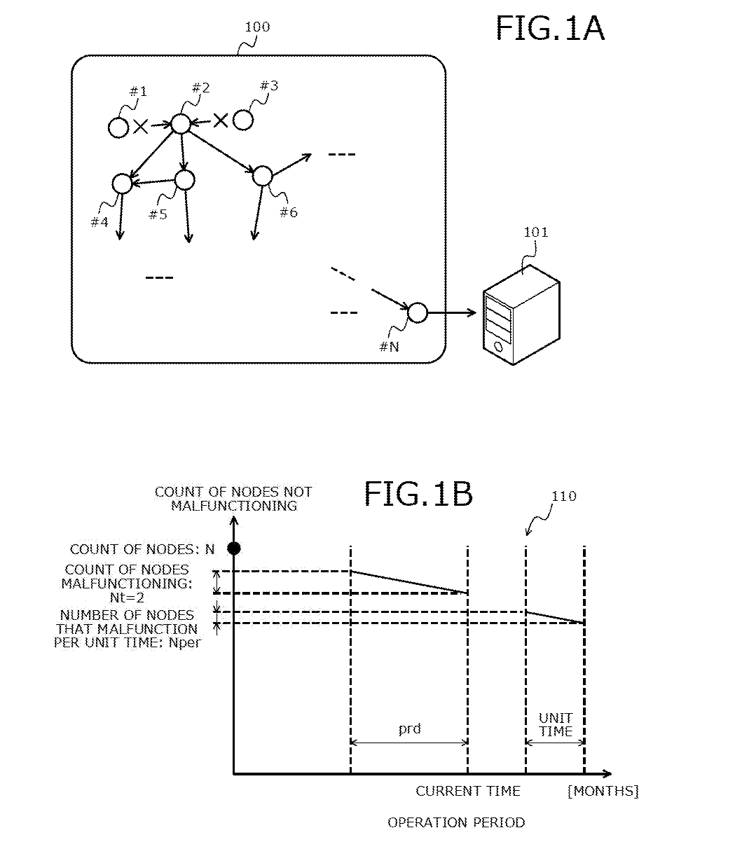

FIGS. 1(A) and 1(B) are diagrams of an operation example of a system according to a first embodiment. A system 100 according to the first embodiment includes plural nodes #1 to N, where N is an integer of 2 or greater. Each of the plural nodes #1 to N is a communications apparatus. The system 100 causes the plural nodes #1 to N to execute processing. For example, the plural nodes #1 to N are dispersed in a predetermined area and the system 100 has a function of obtaining measurement results obtained by sensors of each of the nodes and providing information concerning the predetermined area to a user of the system 100. The system 100 may have a function of causing the plural nodes #1 to N to execute distributed processing of a process and may provide a result of a given process to the user within a given period.

Here, the system 100 is a system configured to enable a function to be realized even when among the plural nodes #1 to N, a portion of the nodes have failed. In particular, when N, which represents a count of the plural nodes, is greater than the number of nodes necessary to realize a function, the system 100 becomes a system capable of realizing the function even when a portion of the plural nodes #1 to N malfunction. Here, a malfunctioning node is a node that cannot communicate. An example of cases where a node cannot communicate includes a case where a portion of the hardware configuring the node fails as a result of aging and a case where the power of the plural nodes #1 to N has been exhausted.

A warranty period during which functions can be guaranteed to be maintained may be set for general industrial products. Although there are many instances where an industrial product can continue to function even when the period of operation has exceeded the warranty period, malfunction can occur instantaneously any time after the warranty period has expired, making prediction of the timing when the product can no longer function difficult.

Thus, an analysis apparatus 101 according to the present embodiment calculates from the number of the nodes that malfunction during a period of operation of the system 100 configured function even when a portion of the nodes among the plural nodes #1 to N malfunction, the number of nodes that malfunction per unit time after the period. As a result, the analysis apparatus 101 enables prediction of the timing when a failure of the system 100 will occur. For example, the analysis apparatus 101 may use the number of the nodes that malfunction per unit time after the period to calculate as the timing when a failure of the system 100 will occur, the time when the number of the nodes that are not malfunctioning falls below the number of nodes needed to maintain a function. An operator of the system 100 may view the number of nodes that malfunction per unit time after the period and thereby predict the timing when a failure of the system 100 will occur.

The analysis apparatus 101 is a computer than when a portion of nodes among the plural nodes #1 to N are malfunctioning, calculates the number of nodes that malfunction per unit time after the period during which the portion of nodes malfunction, enabling prediction of the timing when a failure of the system 100 will occur. The relation of the analysis apparatus 101 and the system 100 may be such that the analysis apparatus 101 is directly connected to the system 100 and detects the number of malfunctioning nodes. Alternatively, the system 100 may be blocked from an external network. In this case, a mobile terminal that can be connected to the system 100 may obtain the number of nodes that are malfunctioning among the plural nodes #1 to N and the analysis apparatus 101 may detect from the mobile terminal, the number of nodes that are malfunctioning.

Concerning detection of the number of nodes that are malfunctioning, the analysis apparatus 101 may make the detection or a node near a malfunctioning node may make the detection. In an example where the analysis apparatus 101 makes the detection, the analysis apparatus 101 is assumed to periodically receive data from the plural nodes #1 to N. When the data count at a subsequent time point is less than the data count at the previous time point, the analysis apparatus 101 detects the difference of the data count at the previous time point and at the subsequent time point as the number of nodes that are malfunctioning. In a case where a node near a malfunctioning node makes the detection, for example, despite receiving data from a nearby node at a time point, a node receives no data at the subsequent time point, whereby the node detects that the nearby node is malfunctioning.

FIG. 1(A) depicts an example where the analysis apparatus 101 is directly connected to the system 100. FIG. 1(A) depicts an example where nodes #1, 3 have malfunctioned during a period prd. The period prd may be any period during operation of the system 100. For example, the period prd may be a period from the start time of operation of the system 100 until the current time, a period from the time when a malfunctioning node is first detected since the start of operation of the system 100 until the current time, and the like.

The analysis apparatus 101 detects the number of nodes that are malfunctioning among the plural nodes in a period during operation of the system 100. In the example depicted in FIG. 1(A), the analysis apparatus 101 detects that a malfunctioning node count Nt during the period prd is 2. The analysis apparatus 101 detects based on the detected number of nodes that are malfunctioning and the period prd, the number Nper of the nodes that malfunction per unit time after the period prd. The unit of time may be any time interval. For example, the system 100 may set the unit of time to be 1 day, 10 days, 1 month, and the like.

FIG. 1(B) depicts using a graph 110, calculated values of the number of nodes that malfunction per unit time. The horizontal axis of the graph 110 represents the operation period and the vertical axis represents the number of nodes that are not malfunctioning. For example, the analysis apparatus 101 calculates Nper=Nt/prd.

After calculating Nper, the analysis apparatus 101 outputs Nper. The operator of the system 100 views Nper and, for example, determines whether nodes are to be added to the system 100. For example, when Nper is greater than a value assumed by the operator of the system 100, the operator determines that nodes are to be added to the system 100.

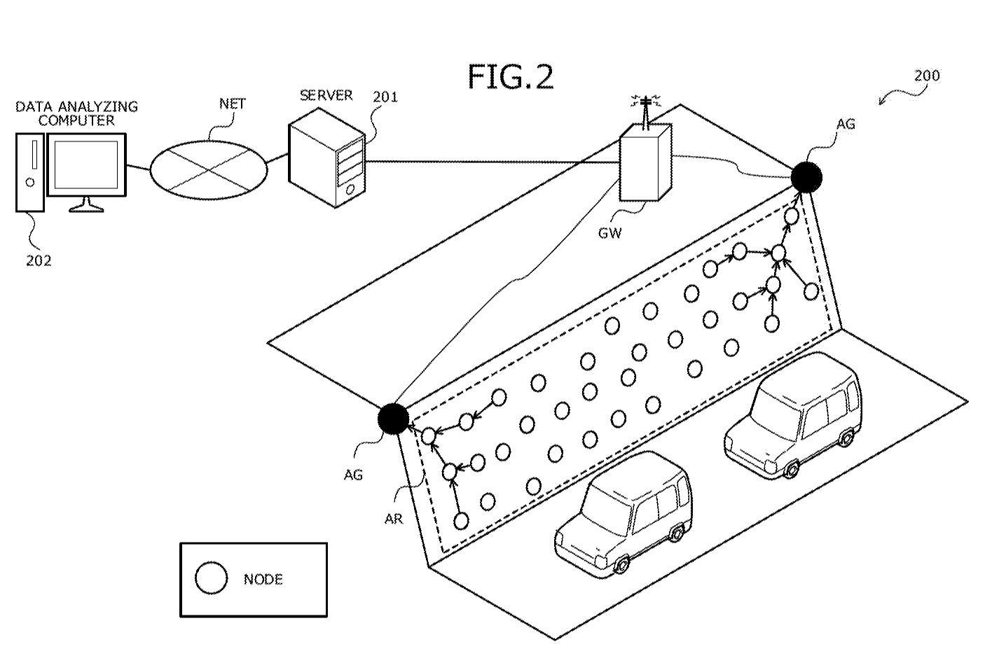

An example of application of the system 100 to a sensor network system will be described with reference to FIG. 2.

FIG. 2 is a diagram depicting an example of connection of a sensor network system according to the first embodiment. A sensor network system 200 is a system in which the plural nodes #1 to N communicate with each other, and is configured to collect data of the nodes. The sensor network system 200 includes the plural nodes #1 to N, an aggregating apparatus AG, a gateway GW, a server 201, and a data analysing computer 202. The server 201 and the data analyzing computer 202 are connected by a network NET. Here, the server 201 corresponds to the analysis apparatus 101 depicted in FIG. 1.

The sensor network system 200 disposes plural nodes in a sensing field AR such as a slope and based on pressure values measured by sensors included in the nodes, monitors the sensing field AR for collapse. Without limitation to a slope, the nodes, for example, may be disposed in an area filled with a substance such as concrete, soil, water, air, and the like, like a building or agricultural field. The sensors included in the nodes, for example, may measure temperature, water volume, the magnitude of vibration, and the like.

Each of the nodes transmits and receives data by multihop communication along periodically set communication paths. The communication paths may be set at the start of operation of the sensor network system 200, when nodes are added, and the like.

The aggregating apparatus AG is an apparatus that aggregates received collection data and transmits the aggregated data to the server 201. The aggregating apparatus AG may be a node having a sensor.

The gateway GW is an apparatus that transmits to the aggregating apparatus AG, a signal from the server 201 and further transmits to the server 201, a signal from the aggregating apparatus AG.

The server 201 is a computer configured to calculate the number of nodes that are malfunctioning per unit time among the nodes dispersed in the sensor network system 200.

The data analysing computer 202 is a computer configured to use the collected data and analyze the state of the sensing field AR.

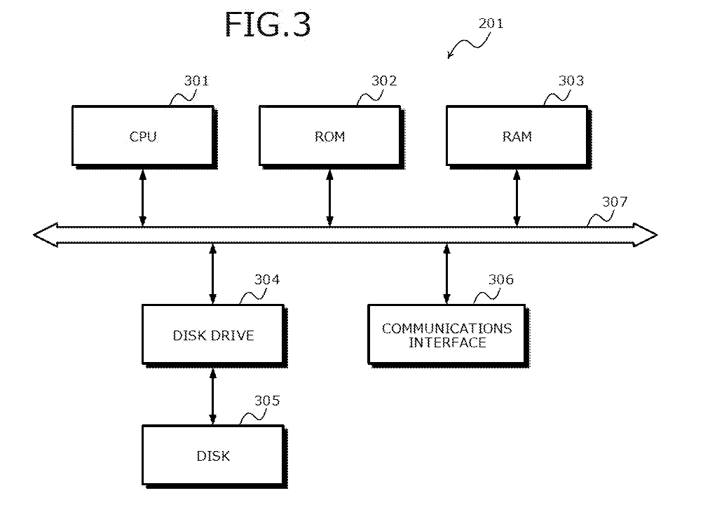

FIG. 3 is a block diagram of an example of hardware configuration of the server. In FIG. 3, the server 201 includes a central processing unit (CPU) 301, read-only memory (ROM) 302, and random access memory (RAM) 303. The server 201 further includes a disk drive 304, a disk 305, and a communications interface 306. The CPU 301 to the communications interface 306 are respectively connected by a bus 307.

The CPU 301 is a computing processing apparatus that governs overall control of the server 201. The ROM 302 is non-volatile memory storing therein programs such as a boot program. The RAM 303 is volatile memory used as a work area of the CPU 301.

The disk drive 304 is a control apparatus that, under the control of the CPU 301, controls the reading and writing of data with respect to the disk 305. The disk drive 304, for example, may be a magnetic disk drive, solid state drive, and the like. The disk 305 is non-volatile memory storing therein data written thereto under the control of the disk drive 304. For example, when the disk drive 304 is a magnetic disk drive, the disk 305 may be a magnetic disk. When the disk drive 304 is a solid state drive, the disk 305 may be semiconductor memory formed by semiconductor devices, a so-called semiconductor disk.

The communications interface 306 is a control apparatus that administers an internal interface with the network and controls the input and output of data with respect to other apparatuses. In particular, the communications interface 306 is connected to other apparatus through a communications line, via the network. The communications interface 306, for example, may be a modem, a LAN adapter, and the like.

When the operator of the sensor network system 200 directly operates the server 201, the server 201 may further include hardware such as a display, a keyboard, and a mouse.

Although not depicted, the hardware configuration of the data analyzing computer 202 includes a CPU, ROM, RAM, a disk drive, a disk, a communications interface, a display, a keyboard, and a mouse.

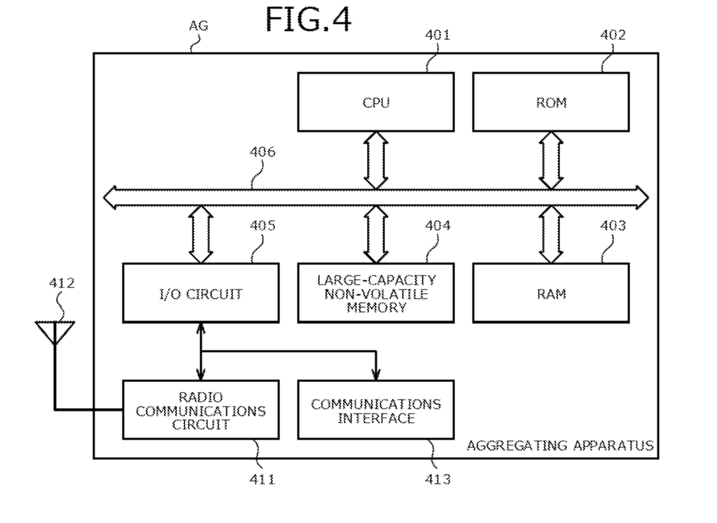

FIG. 4 is a block diagram of an example of hardware configuration of the data aggregating apparatus. The aggregating apparatus AG includes a CPU 401, ROM 402, RAM 403, large-capacity non-volatile memory 404, an I/O circuit 405, a radio communications circuit 411, an antenna 412, and a communications interface 413. The CPU 401 is a computing processing apparatus that governs overall control of the aggregating apparatus AG. The aggregating apparatus AG further has a bus 406 that connects the CPU 401, the ROM 402, the RAM 403, the large-capacity non-volatile memory 404, and the I/O circuit 405. The aggregating apparatus AG, unlike the nodes, may operate by an external power source, or may operate by an internal power source. The large-capacity non-volatile memory 404 is a readable and writable storage apparatus, and retains predetermined data written thereto, even when power supply ceases. For example, the large-capacity non-volatile memory 404 may be a HDD, flash memory, or the like.

The I/O circuit 405 is connected to the radio communications circuit 411, the antenna 412, and the communications interface 413. Thus, the aggregating apparatus AG can wirelessly communicate with nearby nodes, via the radio communications circuit 411 and the antenna 412. The aggregating apparatus AG can communicate with the server 201, via the communications interlace 413, through an IP protocol process.

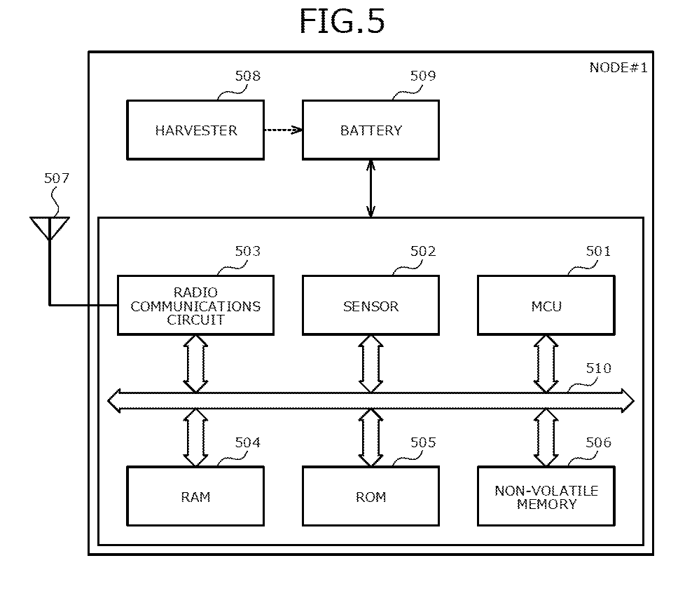

FIG. 5 is a block diagram of an example of hardware configuration of a node. An example of hardware configuration of a node will be described with reference to FIG. 5, taking node #1 among the plural nodes #1 to N as an example. Other nodes other than node #1 also have the same configuration as node #1. Node #1 has a microprocessor (hereinafter, micro control unit (MCU) 501, sensor 502, a radio communications circuit 503, RAM 504, ROM 505, non-volatile memory 506, an antenna 507, a harvester 508, and a battery 509. Node #1 has a bus 510 that connects the MCU 501, the sensor 502, the radio communications circuit 503, the RAM 504, the ROM 505, and the non-volatile memory 506.

The MCU 501 is a computing processing apparatus that governs overall control of node #1. For example, the MCU 501 processes data concerning detection by the sensor 502. The sensor 502 is an apparatus that detects a predetermined change at the installation site. The sensor 502, for example, is a piezoelectric device that detects pressure at the installation site, device that detects temperature, an optoelectronic device that detects light, and the like. The antenna 507 transmits a received radio waved wirelessly communicated with a parent device. The radio communications circuit 503 (radio frequency (RF)) outputs received radio waves as a received signal and transmits radio waves as a transmission signal, via the antenna 507. The radio communications circuit 503 may be a communications circuit that adopts near field radio communication enabling communication with other nearby nodes within a vicinity of a few tens of centimeters.

The RAM 504 is a storage apparatus storing transient data related to processing at the MCU 501. The ROM 505 is a storage apparatus storing therein process programs executed by the MCU 501. The non-volatile memory 506 is a readable/writable storage apparatus and retains predetermined data written thereto even when power supply ceases. For example, the non-volatile memory 506 may be flash memory.

The harvester 508 is the energy harvesting device described in FIG. 1, and is an apparatus that generates power based on energy changes such as in light, vibration, temperature, radio waves (received radio waves) in the external environment at the installation site of node #1. The harvester 508 may generate power corresponding to a difference detected by the sensor 502. The battery 509 is an apparatus that stores the power generated by the harvester 508. In other words, node #1 does not require an external power source and internally generates the power required for operation.

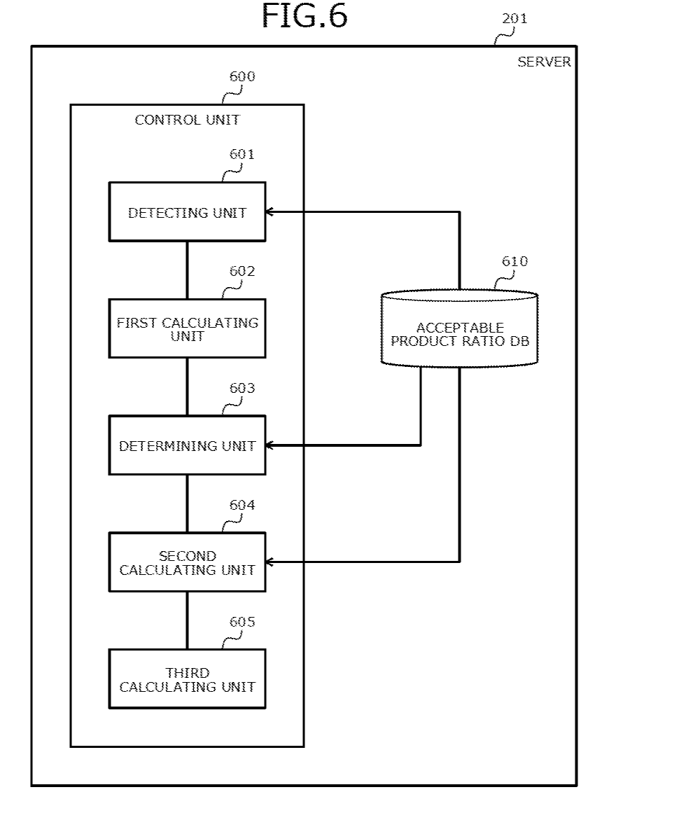

FIG. 6 is a block diagram of an example of a functional configuration of the server according to the first embodiment. The server 201 includes a control unit 600, and an acceptable product ratio DB 610. The control unit 600 includes a detecting unit 601, a first calculating unit 602, a determining unit 603, a second calculating unit 604, and a third calculating unit 605. Functions of the control unit 600 are implemented by the CPU 301 executing the analysis program of the first embodiment and stored in a storage apparatus. The storage apparatus, for example, is the ROM 302, the RAM 303, or the disk 305 depicted in FIG. 3. Process results of the detecting unit 601 to the third calculating unit 605 are stored to a register of the CPU 301, the RAM 303, or the like.

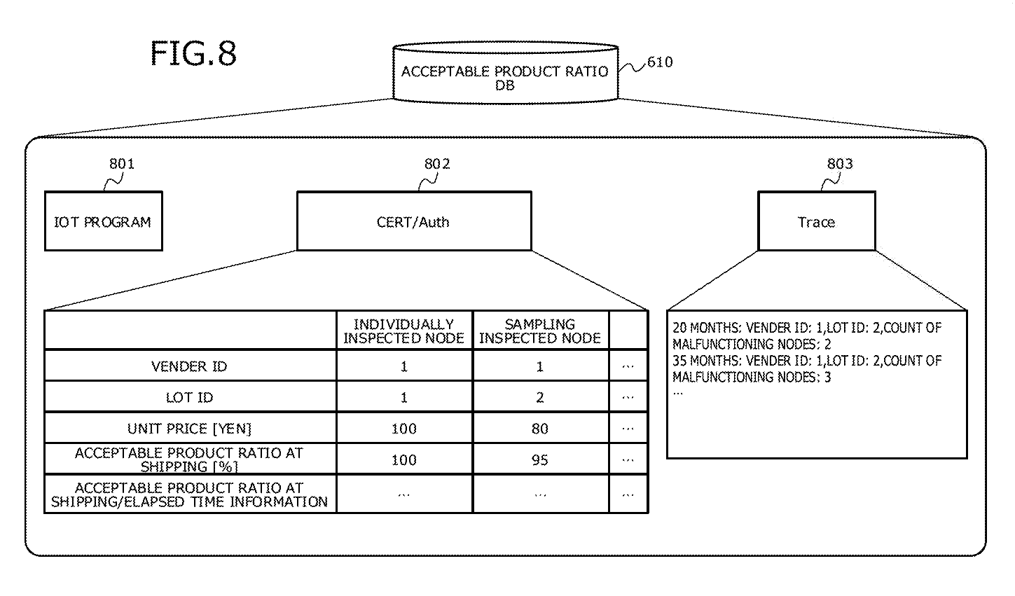

The server 201 is configured to access the acceptable product ratio DB 610. The acceptable product ratio DB 610 is stored in a storage apparatus such as the RAM 303 and the disk 305. An example of the contents of the acceptable product ratio DB 610 will be described with reference to FIG. 8.

The detecting unit 601 detects the number of nodes that are malfunctioning among the plural nodes #1 to N in a period during operation of the sensor network system 200. For example, the detecting unit 601 detects as the number of nodes that are malfunctioning, the difference of the number of nodes that can communicate among the plural nodes #1 to N at the start time of a period and the number of nodes that can communicate at the end time of the period.

The first calculating unit 602 calculates based on the number of nodes that are malfunctioning detected by the detecting unit 601, the number of nodes that malfunction per unit time after the period.

The first calculating unit 602 may calculate based on the number of nodes that malfunction per unit time and the number of nodes that are not malfunctioning among the plural nodes #1 to N at the end time of the period, the number of nodes not malfunctioning at a time point after the period. Here, a node that is not malfunctioning is a node that can communicate. Hereinafter, a node that is not malfunctioning may be referred to as “operating node”.

For example, the number of nodes that malfunction per unit time is assumed to be Nt and the number of nodes that are not malfunctioning among the plural nodes #1 to N at an end time Tend of the period is assumed to be Nend. In this case, the first calculating unit 602 calculates the number of nodes that are not malfunctioning at a time t as Nend−Kt×(t-Tend)/unit time.

The determining unit 603 determines based on the number of nodes that malfunction per unit time and the number of nodes that are not malfunctioning among the plural nodes at the end time of the period, whether the number of nodes that are not malfunctioning at a time point after the period is less than a predetermined number. Here, the predetermined number is a value that represents the number of nodes that enable realization of a function. Hereinafter, the predetermined number will be referred to as “function maintaining threshold”. The function maintaining threshold is stored in the acceptable product ratio DB 610, the RAM 303, or the like. Concerning the number of nodes not malfunctioning at a time point after a period, the determining unit 603 obtains the number by the same method as the first calculating unit 602.

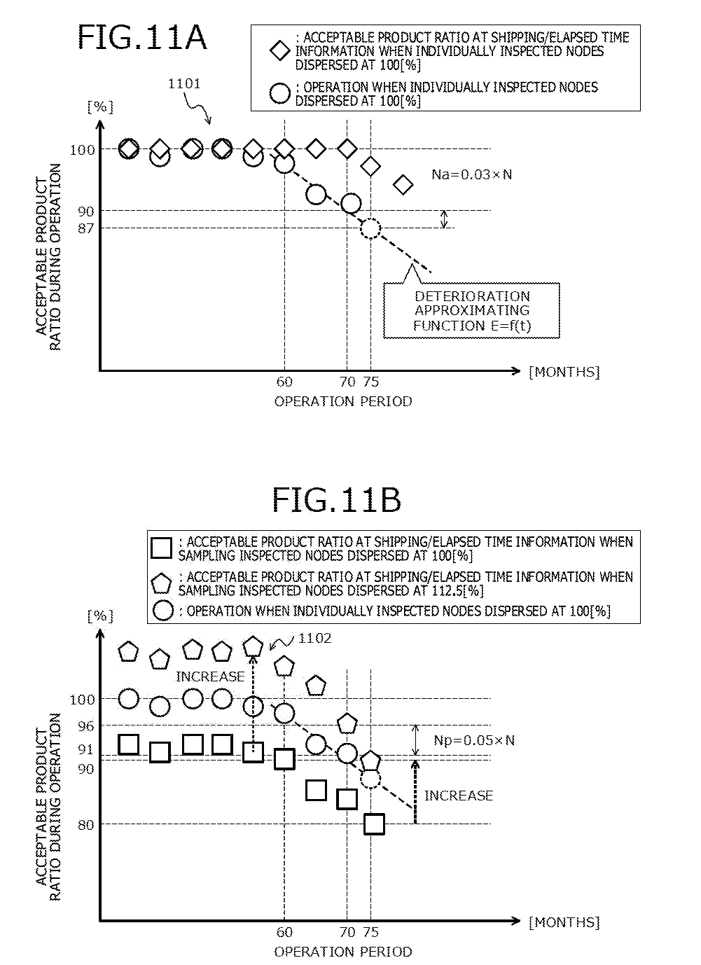

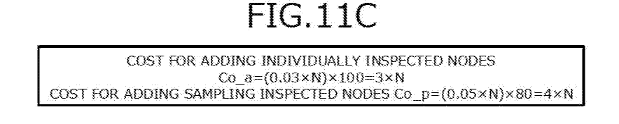

The determining unit 603 is assumed to determine that the number of nodes not malfunctioning at a time point is less than the function maintaining threshold. In this case, the second calculating unit 604 calculates based on the number of nodes not malfunctioning at the time point and the function maintaining threshold, the number of nodes that are to be added to the sensor network system 200 before the time point. A calculation example for the number of nodes to be added will be described with reference to FIG. 11.

The second calculating unit 604 may calculate the number of nodes to be added, based on an acceptable product ratio pre-stored to the acceptable product ratio DB 610, the number of nodes that are not malfunctioning at the time point, and the function maintaining threshold. The second calculating unit 604 may calculate for each lot (manufacturing unit for node manufacturing), the number of nodes to be added, based on the node acceptable product ratio per lot, the number of nodes not malfunctioning at the time point, and the function maintaining threshold. An example of calculating the number of nodes to be added based on the acceptable product ratio will be described with reference to FIG. 11.

The third calculating unit 605 calculates for each lot, the cost of adding the calculated number of nodes to the sensor network system 200, based on the calculated number of nodes to be added and a node unit price for a lot, pre-stored in the acceptable product ratio DB 610. An example of calculating cost will be described with reference to FIG. 11.

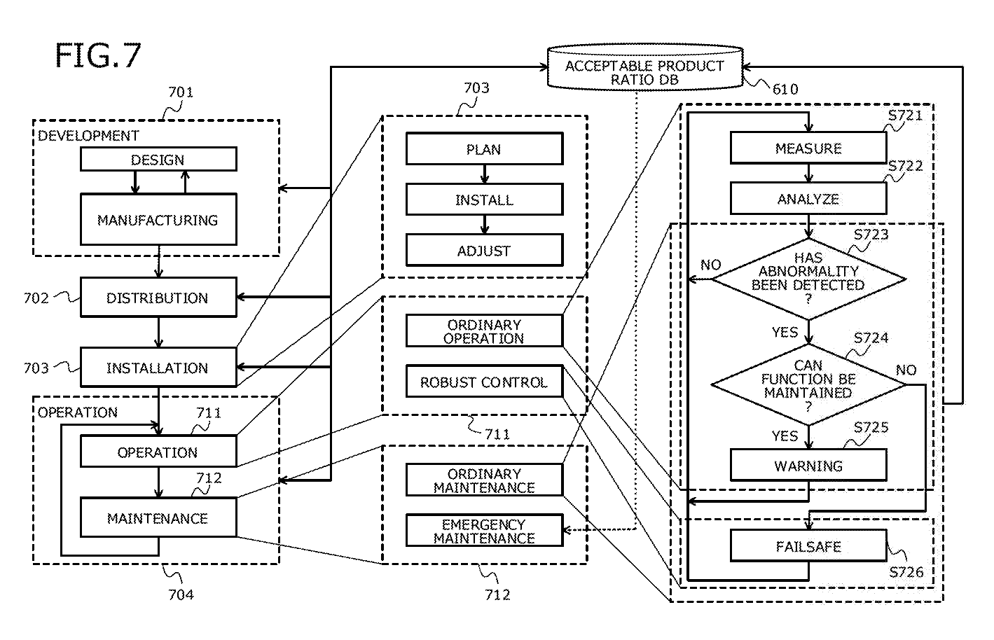

FIG. 7 is a diagram depicting scenarios from the development of the sensor network system until operation. The scenarios from development until operation, roughly classified, include a development scenario 701, a distributing scenario 702, an installing scenario 703, and an operating scenario 704. Information generated during the scenarios from development to operation is stored to the acceptable product ratio DB 610. The acceptable product ratio DB 610 is a database of the server 201.

The development scenario 701 is a scenario of repeatedly performing node design and manufacturing by a manufacturer. After final inspection of the manufactured nodes has been completed, the designer provides to the distributor, the manufactured nodes, and a recording medium storing therein a vender ID identifying the manufacturer and a lot ID identifying the lot (respectively affixed to the nodes) and a program for interoperability testing (IOT) performed by the server 201.

A lot will be described. A lot is a manufacturing unit in the manufacture of the nodes. Concerning nodes of low-volume production and high-unit price, the manufacturer inspects each product and counts a precise yield ratio. Further, for high-unit price nodes, to increase the acceptable product ratio, the manufacturer may spend more at the time of manufacturing, consider circuit redundancy at the time of design, and the like. On the other hand, concerning high-volume production, low-cost nodes, the manufacturer may manage yield ratio in units of lots and by sampling inspection.

Thus, at the final inspection, all of the products are inspected, or sampling inspection is performed. The manufacturer, at the shipping stage, further stores to the recording medium, the acceptable product ratio which indicates the ratio of acceptable products among a node group included in the lot. The acceptable product ratio is a value that fluctuates according to whether each node has been inspected, or sampling inspection has been performed. Hereinafter, a node in a case where each node is subject to inspection will be referred to as “individually inspected node”. A node in a case where sampling inspection is performed will be referred to as “sampling inspected node”. Even when individually inspected nodes and sampling inspected nodes are present in the same sensing field AR, if the same protocol can be executed, the sensor network system 200 can be built.

At the time of manufacturing or at the time of inspection, the manufacturer associates and stores to the recording medium, an operation period that is obtained by operating the nodes or by simulating operation of the nodes, acceptable product ratio during the operation period, and acceptable product ratio at shipping/elapsed time information. The acceptable product ratio at shipping and the acceptable product ratio at shipping/elapsed time information are described with reference to FIG. 8. The acceptable product ratio at shipping/elapsed time information is depicted in FIG. 11.

The distributing scenario 702 is a scenario after manufacturing by the manufacturer, and is a scenario of distributing the nodes and recording medium by a distributor. The installing scenario 703 is a scenario of installing the nodes by installation personnel of the sensor network system 200 for which the nodes and recording medium were purchased from the distributor. In particular, the installing scenario 703 is a scenario of planning the installation sites of the nodes, installing the nodes, and adjusting the installed nodes by installation personnel. The server 201 stores to the acceptable product ratio DB 610 via an operation by installation personnel, the information stored in the recording medium, the total number of nodes installed, and the unit price of the nodes based on the selling price of the nodes and the recording medium at the time of purchase.

The operating scenario 704 is a scenario of operating the sensor network system 200 by the operator of the sensor network system 200. More specifically, the operating scenario 704 repeats an operation sub-scenario 711 and a maintenance sub-scenario 712.

The operation sub-scenario 711 is a scenario of performing ordinary operation and robust control by the operator. Ordinary operation, for example, is operation performed every 10 minutes. Robust control is operation performed when a minor error occurs.

The maintenance sub-scenario 712 is a scenario of performing ordinary maintenance and emergency maintenance. Ordinary maintenance is maintenance performed periodically. Emergency maintenance is maintenance performed urgently. For example, emergency maintenance is when a fatal defect in the hardware of an installed node is detected and the operator replaces the installed node with a node for which the defect has been resolved. If the defect can be repaired, the operator repairs the location having the defective nodes among the installed nodes. If the defect can be resolved by hardware having an additional function, the operator adds the hardware to the installed nodes.

Ordinary operation, robust control, and ordinary maintenance are implemented by the server 201 and the nodes executing steps S721 to S726 in FIG. 7. In particular, ordinary operation is implemented by an execution of steps S721 to S725. Robust control is executed by an execution of step S726. Ordinary maintenance is implemented by an execution of steps S723 to S726.

The nodes measure the state of the surroundings (step S721). The data analyzing computer 202 uses the collected data to analyze the state of the nodes in the sensing field A (step S722). The server 201 determines whether an abnormality has been detected (step S723). For example, in a case where the nodes periodically send data to the server 201, if a node from which previously transmitted data is received but currently transmitted data is not, the server 201 determines that an abnormality has been detected.

If no abnormality has been detected (step S723: NO), the server 201 continues to receive data from the nodes. If an abnormality has been detected (step S723: YES), the server 201 determines whether function can be maintained (step S724). Determination of whether function can be maintained may be performed by comparison of the number of nodes that are not malfunctioning and the function maintaining threshold.

If function can be maintained (step S724: YES), the server 201 outputs a warning to the data analyzing computer 202, etc. (step S725), and continues to receive data from the nodes. If function cannot be maintained (step S724: NO), the server 201 outputs indication that a failsafe measure is to be performed (step 726), and continues to receive data from the nodes. The operator who sees the indication that a failsafe measure is to be taken adds and disperses nodes as a countermeasure.

FIG. 8 is a diagram depicting an example of the contents of the acceptable product ratio DB. The acceptable product ratio DB 610 stores an IOT program 801, CERT/Auth 802, and a Trace 803. The IOT program 801 is a program executed by the server 201 at the time of the installing scenario 703 and the operating scenario 704. For example, the server 201, according to the IOT program 801, notifies the nodes of a request for the vender ID and the lot ID. If a node is present that does not send notification of the IDs, or if a node is present that sends notification of an ID other than the vender IDs and lot IDs registered in the acceptable product ratio DB 610, the server 201 processes the ID as an unknown ID.

The CERT/Auth 802 records for each combination of vender ID and lot ID, node related information. In particular, the CERT/Auth 302 stores vender IDs, lot IDs, unit prices, acceptable product ratios at shipping, and acceptable product ratio at shipping/elapsed time information.

The vender ID is information specified by the manufacturer of the node. The lot ID is information identifying the lot. The unit price is the price per node and is based on the selling price of the node and the recording medium at the time of purchase. The acceptable product ratio at shipping indicates the ratio of nodes that at the shipping stage, are acceptable products among a node group identified by the vender ID and the lot ID. For example, since individually inspected nodes are each guaranteed to be an acceptable product, the acceptable product ratio at shipping is 100 [%]. The acceptable product ratio at shipping/elapsed time information is information associated with the operation period of a node group specified by the vender ID and the lot ID, and the acceptable product ratio indicating the ratio of nodes that are acceptable products among the node group during operation. For example, the acceptable product ratio at shipping/elapsed time information is information indicating that when 100 nodes specified by the vender ID and the lot ID are operated, after 60 months 1 node will malfunction, and after 61 months, 2 nodes will malfunction. An amortized unit value is the purchase unit price for a node group specified by the vender ID and lot ID, divided by the operation period.

For example, in FIG. 8, an individually inspected node is affixed with “1” as the vender ID and “1” as the lot ID, has a unit price of 100[yen] and an acceptable product ratio at shipping of 100[%].

The Trace 803 is data recording state changes occurring during operation of the sensor network system 200. For example, the Trace 803 records the number of nodes that malfunction among a node group specified by the vender ID and the lot ID, since the start of operation of the sensor network system 200.

For example, in FIG. 8, the number of sampling inspected nodes affixed with the vender ID “1” and the lot ID “2” and malfunctioning during the 20th month of operation is 2 and the number of sampling inspected nodes malfunctioning in the 35th month is 3.

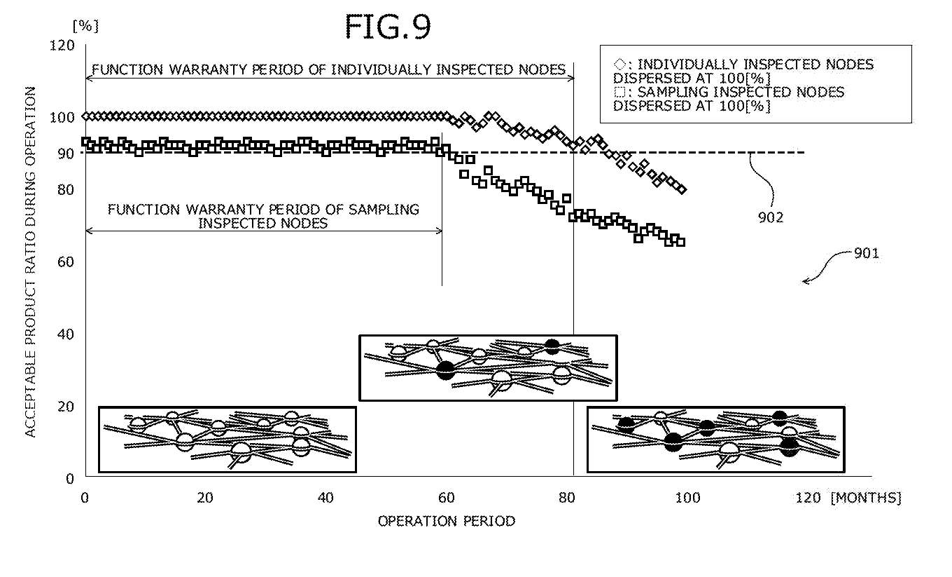

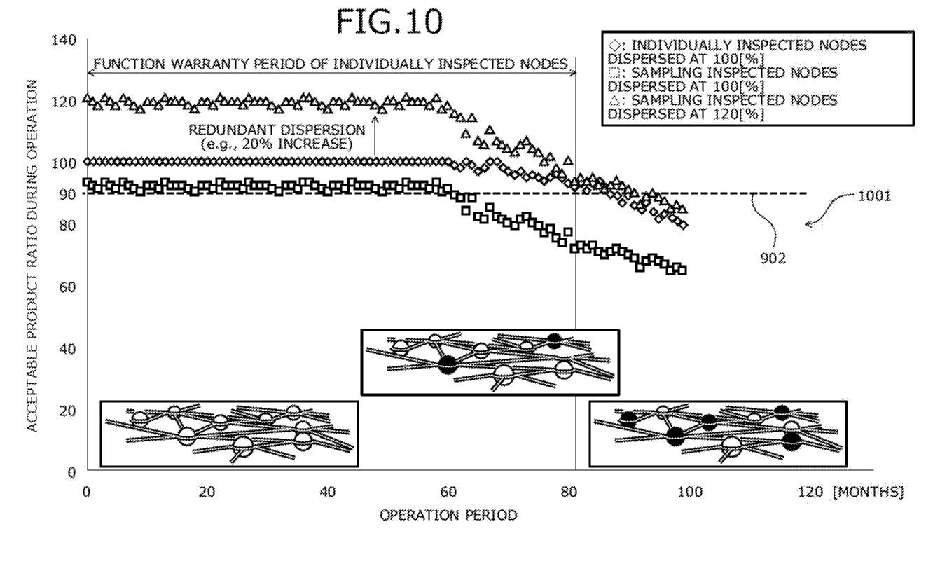

The acceptable product ratio at shipping/elapsed time information for individually inspected products and for sampling inspected products is illustrated using FIGS. 9 and 10. FIG. 9 depicts an example where individually inspected products are dispersed without being excessive or insufficient and sampling inspected products are dispersed without being excessive or insufficient. FIG. 10 depicts an example where sampling inspected products are dispersed with redundancy. The acceptable product ratio at shipping/elapsed time information depicted in FIGS. 9 and 10 is a result of simulation where malfunctioning nodes are randomly added.

FIG. 9 is a diagram depicting an example of the acceptable product ratio over time for individually inspected products and for sampling inspected products. In FIG. 9, a graph 901 plotting acceptable product ratio at shipping/elapsed time information for individually inspected node and acceptable product ratio at shipping/elapsed time information for sampling inspected nodes is used to temporally describe the acceptable product ratio during operation. The acceptable product ratio during operation indicates the ratio of nodes that are acceptable products with respect to the number of nodes that are to be dispersed in the sensing field AR during operation of the sensor network system 200. The number of nodes that are to be dispersed in the sensing field AR is a value specified by the operator of the sensor network system 200. For example, the operator specifies the area of the sensing field AR divided by the area in which a node can communicate with a nearby node to be the number of nodes that are to be dispersed in the sensing field AR.

The graph 901 temporally depicts the acceptable product ratio during operation. The horizontal axis in the graph 301 represents the operation period and the vertical axis represents the acceptable product ratio during operation. A threshold of the acceptable product ratio during operation and enabling function of the sensor network system 200 is assumed to be 90[%] as indicated by a dotted line 902.

When the individually inspected nodes ate dispersed at 100[%], the individually inspected nodes are assumed to demonstrate the characteristics indicated by the plot of white diamond shapes. The graph 901 depicts an example when the sensor network system 200, in which the individually inspected nodes are dispersed at 100[%], continues to be operated and after about the 60 months, gradually begins to malfunction consequent to aging. Here, with respect to the elapse of time, the acceptable product ratio during operation may fluctuate slightly consequent to temporal, local malfunctions; however, overall, the acceptable product ratio monotonically decreases. The acceptable product ratio during operation is assumed to drop below the dotted line 902 around the 82nd month. The period from the start time of operation until the drop below the dotted line 902 is called “function warranty period”. The function warranty period when the individually inspected nodes are dispersed at 100[%] is 82 months.

The acceptable product ratio at shipping/elapsed time information, and the acceptable product ratio during operation of the sensor network system 200, with respect to the elapse of time may indicate different trends as a result of the environment not being uniform. In other words, consequent to the operating environment, malfunction may occur sooner or later than expected. As a result, using the acceptable product ratio at shipping/elapsed time information to perform a simple interpolation process alone does not enable formulation of deterioration characteristics of the operating nodes of the sensor network system 200.

When the sampling inspected nodes are dispersed at 100[%], the sampling inspected nodes are assumed to demonstrate the characteristics indicated by the plot of white squares. With the sampling inspected nodes, since the acceptable product ratio at shipping is 95%, the sampling inspected nodes have a certain difference in quality and like the individually inspected nodes, deterioration in quality begins. The graph 901 depicts an example where at the 60-month mark, the acceptable product ratio during operation drops below the function maintaining threshold. The function warranty period when the sampling inspected nodes are dispersed at 100[%] is 60 months. With the sampling inspected nodes as well, deterioration characteristics from the time of shipping cannot be expressed by a simple formula.

FIG. 10 is a diagram depicting temporally the acceptable product ratio during operation when sampling inspected products are dispersed with redundancy. In FIG. 10, a graph 1001 plotting acceptable product ratio at shipping/elapsed time information for sampling inspected nodes dispersed at 120[%], with respect to the state depicted by the graph 901 is used to temporally described the acceptable product ratio during operation.

When the sampling inspected nodes are dispersed at 120[%], the sampling inspected nodes are assumed to demonstrate the characteristics indicated by the plot of the white triangles. The plot when the sampling inspected nodes are dispersed at 120[%] results when the plot for the sampling inspected nodes dispersed at 100[%] is increased in the vertical direction by 20[%].

Although the quality of the sampling inspected nodes is not stable, in the example depicted in FIG. 10, by dispersing 20[%] more nodes, the point at the 82-month mark, which is the function warranty period of the individually inspected nodes, may be reached by the addition of the nodes.

A determination method of whether additional nodes are to be dispersed and if so, the number to be added will be described with reference to FIG. 11.

FIGS. 11(A), 11(B), and 11(C) are diagrams depicting an example of determining whether additional nodes are to be dispersed and the number of nodes to be added. FIG. 11(A) depicts an example of determining whether additional nodes are to be dispersed and a method of calculating the number of nodes to be added when individually inspected nodes are added. FIG. 11(B) depicts an example of a method of calculating the number of nodes to be added when sampling inspected nodes are added. FIG. 11(C) describes an example of calculating cost, which is an index in determining whether individually inspected nodes or sampling inspected nodes are to be added.

In a graph 1101 depicted in FIG. 11(A), white diamond shapes represent the acceptable product ratio at shipping/elapsed time information when individually inspected nodes are dispersed at 100[%]. White circles represent the nodes that according to the Trace 803, malfunctioned when the sensor network system 200 was actually operated and the individually inspected nodes were dispersed at 100[%].

The graph 1101 temporally depicts the acceptable product ratio during operation. As indicated by the graph 1101, with actual operation of the sensor network system 200, since the environment was worse than assumed by the acceptable product ratio at shipping/elapsed time information, the decrease of the acceptable product ratio during operation began sooner than indicated by the acceptable product ratio at shipping/elapsed time information.

The server 201 refers to the Trace 803 to create a deterioration approximating function E=f(t) representing a malfunction count for the operation period. Here, E is the node malfunction count; and t is the operation period. For example, the server 201 assumes a deterioration approximating function f(t) to be f(t)=at+b, refers to the Trace 803, and creates coefficient a and constant b. As the simplest example of creation, the server 201 obtains a and b by substituting into f(t)=at+b, a malfunctioning node count Ex at the current time tx, and Ey at a time ty when a node is detected to have malfunctioned the previous time. Further, the server 201 may use a malfunction count E at 3 or more time points t to obtain a and b by a least squares method.

The reason the deterioration approximating function E=f(t) is a function using an operation period t will be discussed. Whether nodes malfunction is largely dependent on the environment where the nodes are dispersed and is minimally affected by the acceptable product ratio of the dispersed nodes and the number of dispersed nodes. Therefore, in the present embodiment, the server 201 uses the operation period t and the number of nodes that are malfunctioning E to create the deterioration approximating function E=f(t) and does not use the acceptable product ratio of the dispersed nodes or the number of dispersed nodes.

After creating the deterioration approximating function f(t), the server 201 uses equation (1) to calculate the number of nodes not malfunctioning N′ at a time T+Δt that is after the current time T.

N′=N+α−f(T+Δt) (1)

Where, N is the number of nodes to be dispersed in the sensing field AR, and is the number of nodes initially dispersed; and α is the number of nodes redundantly dispersed. The server 201 determines whether nodes are to be added to the sensor network system 200, according to whether expression (2) is satisfied.

N′<function maintaining threshold (2)

When expression (2) is satisfied, the server 201 determines that nodes are to be added to the sensor network system 200. When expression (2) is not satisfied, the server 201 determines that nodes need not be added to the sensor network system 200. The graph 1101 depicts an example where redundant nodes are not dispersed and therefore, α=0; the current time T is assumed to be the 70th month; a time T+Δt after the current time T is assumed to be the 75th month. In this case, from the graph 1101, f(T+Δt) is (100−87)×0.01×N=0.13×N[nodes]. The server 201 uses equation (1) to calculate N′ as below.

N′=N+0−0.13×N=0.87×N[nodes]

Further, the function maintaining threshold is assumed to be 0.90×N and therefore, the server 201 determines from expression (2), that nodes are to be added to the sensor network system 200.

An example of calculating the number of nodes to be added will be described. A first calculation method and a second calculation method are present as methods of calculating the number of nodes to be added. The first calculation method is a method of dividing the difference of the function maintaining threshold and N′ by the acceptable product ratio at shipping to calculate the number of nodes to be added.

When the first calculation method is used and individually inspected nodes are to be additionally dispersed, the server 201 calculates the number of nodes to be added as (0.90×N−0.87×N)/0.95=0.0316×N[nodes]. When sampling inspected nodes are to be additionally dispersed, the server 201 calculates the number of nodes to be added as (0.90×N−0.87×N)/0.95=0.0316×N[nodes].

The second calculation method is a method of using changes in the plot positions of the acceptable product ratio at shipping/elapsed time information when the number of dispersed nodes is adjusted. Details of the second calculation method will be described using a graph 1102.

In the graph 1102 depicted in FIG. 11(B), white squares represent the acceptable product ratio at shipping/elapsed time information when sampling inspected nodes are dispersed at 100[%]. White circles represent nodes that according to the Trace 803, malfunctioned when the sensor network system 200 was actually operated and the individually inspected nodes were dispersed at 100[%]. White pentagon shapes represent the acceptable product ratio at shipping/elapsed time information when sampling inspected nodes are dispersed at 112.5[%]. The reason for the numeric value of 112.5[%] will be described hereinafter.

In the second calculation method, the number of nodes to be dispersed is determined such that the number of nodes and the function maintaining threshold coincide at a time T+Δt after the current time T. In particular, as depicted by the graph 1102, from the acceptable product ratio at shipping/elapsed time information for a case where sampling inspected nodes are dispersed at 100[%], at a time T+Δt=75th month, the number of nodes not malfunctioning is 80[%]×N nodes. Therefore, the acceptable product ratio at shipping/elapsed time information when sampling inspected nodes are dispersed at (0.90×N)/(0.80×N)=1.125=112.5[%] coincides with the function maintaining threshold at the 75th month.

Further, in the second calculation method, at the current time T, the difference of the acceptable product ratio at shipping/elapsed time information for dispersion at 112.5[%] and the number of nodes that are not malfunctioning when 100[%] of the individually inspected nodes are operated at the current time T is assumed as the number of nodes to be added. In particular, as indicated by the graph 1102, from the acceptable product ratio at shipping/elapsed time information when sampling inspected nodes are dispersed at 112.5[%], at the time point when the current time T=70th month, the number of nodes that are not malfunctioning is 0.96×N[nodes]. Further, the number of nodes that are not malfunctioning when 100[%] of the individually inspected nodes are operated at the current time T is 0.91×N[nodes]. Therefore, the server 201 calculates the number of nodes to be added as (0.96×N−0.91×N)=0.05×N[nodes].

The server 201 uses the calculated number of nodes to be added and calculates the cost for adding the nodes to the sensor network system 200. In particular, the server 201 uses equation (3) to calculate a cost Co for adding the nodes. The cost represented by equation (3) represents an amortized unit value since the cost of the nodes is divided by the operation period that the nodes can be operated for.

cost Co=number of additional nodes×unit price of node/operation period (3)

The server 201 compares results obtained by equation (3) to determine whether individually inspected nodes or sampling inspected nodes are to be added and determines the smaller value to be the nodes to be added. Here, since the operation period is the same value for individually inspected nodes and sampling inspected nodes, the server 201 may use equation (3′) to make the determination.

cost Co=number of additional nodes×node unit price (3′)

An example of calculating cost using equation (3′) is given. The number of individually inspected nodes to be added is assumed to be 0.03×N[nodes] and the number of sampling inspected nodes to be added is assumed to be 0.05×N[nodes]. In this case, in FIG. 11(C), the server 201 uses equation (3′) to calculate a cost Co_a for adding individually inspected nodes and a cost Co_p for adding sampling inspected nodes, as indicated below.

cost Co_a=(0.03×N)×100 =3×N cost Co_p=(0.05×N)×80=4×N

The server 201 compares the cost Co_a and the cost Co_p and outputs indication that individually inspected nodes are to be added. Alternatively, the server 201 may simply output the cost Co_a and the cost Co_p. The operator of the sensor network system 200 views the cost Co_a and the cost Co_p, and determines which is to be added. In the example depicted in FIG. 11(C), the operator determines that individually inspected nodes are to be added since the cost Co_a is relatively lower.

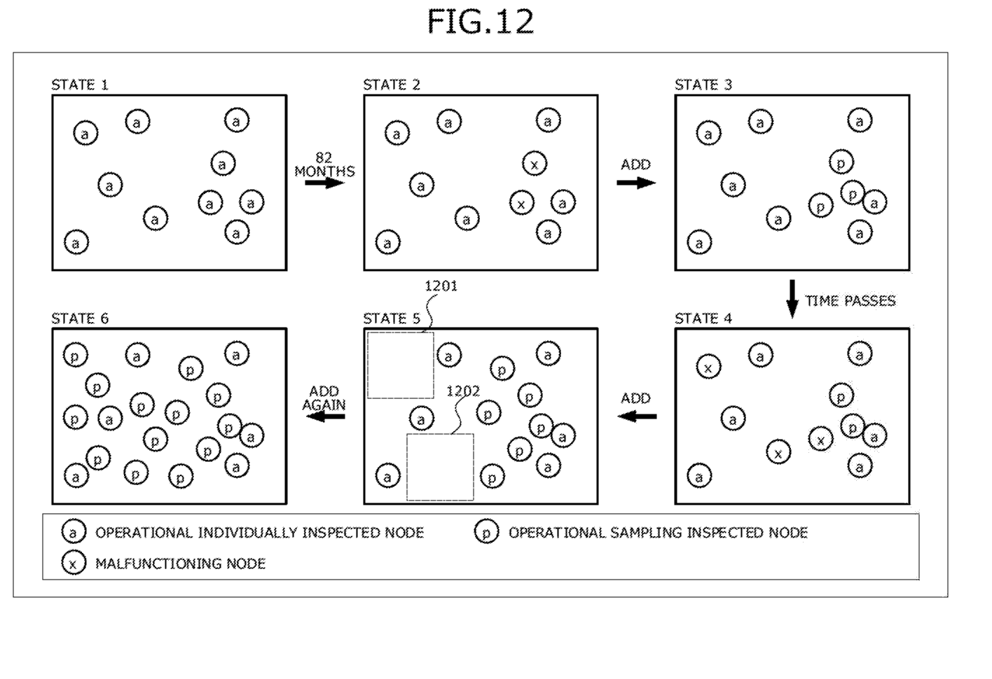

FIG. 12 is a diagram depicting an example of additional node dispersion. FIG. 12 depicts states 1 to 6of node dispersion in the sensor network system 200. In states 1 to 6, a white circle having an “a” represents an individually inspected node that is operable. A white circle having a “p” represents a sampling inspected node that is operable. A white circle having an “x” represents a malfunctioning node.

State 1 depicted in FIG. 12 represents a state at the start time of operation of the sensor network system 200. In state 1, individually inspected nodes are dispersed in the sensor network system 200 and no sampling inspected nodes are dispersed.

State 2 depicted in FIG. 12 represents a state after 82 months have elapsed from state 1. In state 2, two malfunctioning nodes are present and the server 201 determines that nodes are to be added to the sensor network system 200.

State 3 depicted in FIG. 12 is a state subsequent to state 2, in a case where sampling inspected nodes have been additionally dispersed by the operator of the sensor network system 200. Here, when additional nodes are dispersed, whether nodes are insufficient in an area such as the sensing field AR is unknown. In the example, state 3 is a state in a case where by coincidence, the operator disperses additional nodes is an area where nodes are insufficient.

State 4 depicted in FIG. 12 is a state after a certain period has elapsed after the state depicted in FIG. 12. In state 4, three malfunctioning nodes are present and the server 201 determines that nodes are to be added to the sensor network system 200.

State 5 depicted in FIG. 12 is a state after state 4, in a case where sampling inspected nodes have been additionally dispersed by the operator of the sensor network system 200. In state 5, although the operator has added nodes, node dispersion density in areas 1201 and 1202 are low, making function of the sensor network system 200 difficult to maintain. In state 5, the server 201 determines that nodes are to be added to the sensor network system 200.

Here, in state 5 depicted in FIG. 12, the reason the server 201 can determine that nodes are to be added to the sensor network system 200 despite the number of operating nodes being greater than an essential function maintaining threshold will be described. To enable the aforementioned, nodes in the sensor network system 200 have a quality of not communicating with a nearby node when determining that an operating node is nearby. As a method of determining that an operating node is nearby, for example, when the reception strength of received radio waves is a predetermined threshold or greater, an operating node is determined to be nearby.

Thus, a portion of a node group included in an area with a high node dispersion density does not communicate with nearby nodes whereby, the server 201 detects that the number of nodes that are not malfunctioning has decreased and when an area having a low node dispersion density is present, the number drops below the function maintaining threshold. Among a node group included in an area with a high node dispersion density, a node that does not communicate with a nearby node resumes communication with nearby nodes when an operating node malfunctions. Therefore, nodes that do not communicate with nearby nodes will resume communication with nearby nodes at some time and therefore, additionally dispersed nodes are not meaningless.

State 6 depicted in FIG. 12 is a state after state 5, in a case where sampling inspected nodes are additionally dispersed by the operator of the sensor network system 200. In state 6, an area in which the operator dispersed additional nodes overlaps a node-deficient area and therefore, the server 201 determines that nodes need not be additionally dispersed in the sensor network system 200.

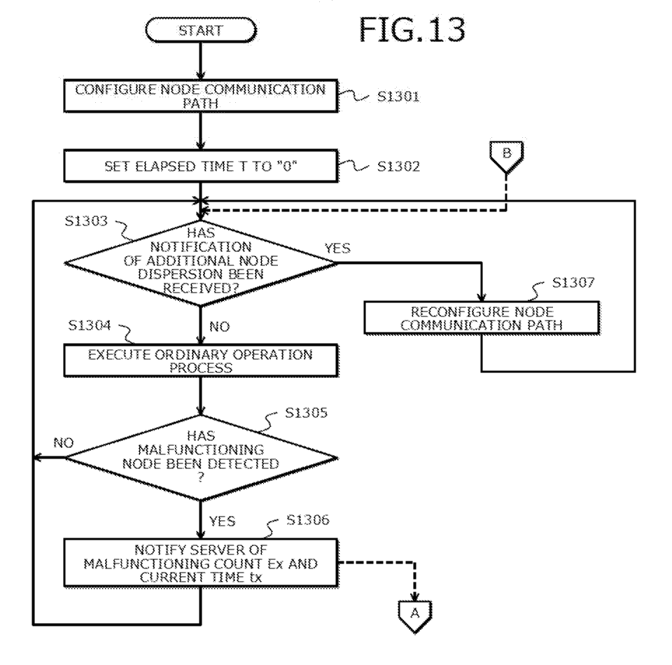

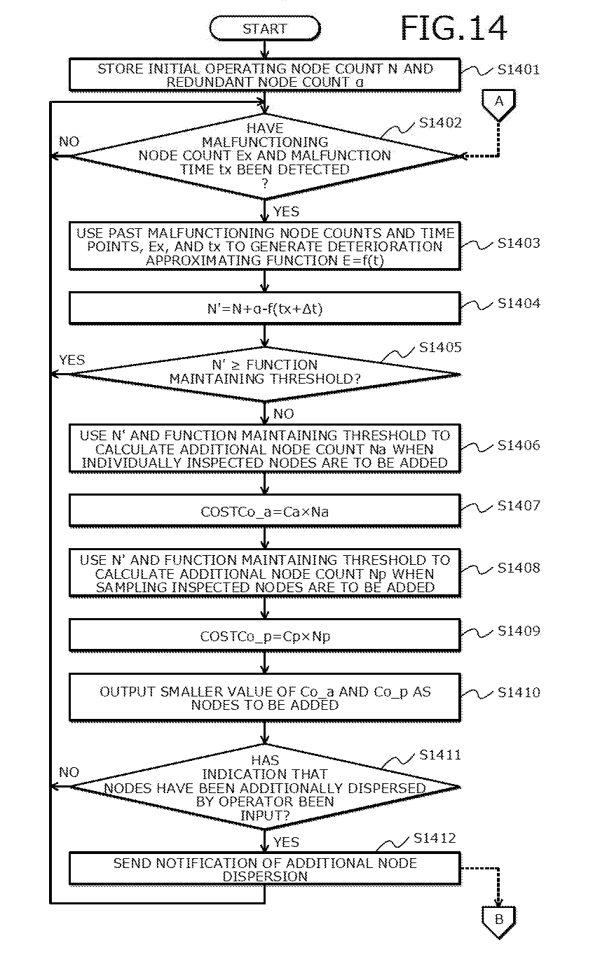

The operation depicted in FIG. 12 is performed for a long period whereby, the server 201 can quantify the amortized unit value and the operator can view the values obtained by equations (3) and (3′) and thereby, create a node dispersion plan that optimizes cost. Flowcharts of operations performed by each of the plural nodes #1 to N and the server 201 will be described with reference to FIGS. 13 and 14.

FIG. 13 is a flowchart of an example of a procedure of a sensor network system operation process by a node. The sensor network system operation process is performed by a node at the start of operation of the sensor network system 200 and during operation. The node configures a node communication path (step S1301), and sets an elapsed time T to 0 (step S1302). Operations at steps S1301 and S1302 are performed at the start time of operation of the sensor network system 200.

The node determines whether notification of additional node dispersion has been received (step S1303). Notification of additional node dispersion is received from the server 201 by an operation at step S1412 described hereinafter. If notification of additional node dispersion has not been received (step S1303: NO), the node executes an ordinary operation process (step S1304). Here, an ordinary operation process is measurement of a state of the surroundings by the sensor 502, a process of transmitting a measurement result by the MCU 501, the radio communications circuit 503, and the antenna 507.

The node determines whether a malfunctioning node has been detected (step S1305). If a malfunctioning node has been detected (step S1305: YES), the node notifies the server of the malfunctioning count Ex and the current time tx (step S1306). After the operation at step S1306, or if no malfunctioning node has been detected (step S1305: NO), the node transitions to the operation at step S1303.

If notification of additional node dispersion has been received (step S1303: YES), the node reconfigures the node communication path (step S1307). After the operation at step S1307, the node transitions to the operation at step S1303. By executing the sensor network system operation process by a node, the node is able to execute an ordinary operation.

FIG. 14 is a flowchart of an example of a procedure of an analysis process. The analysis process is a process of analysing the state of a node in the sensor network system 200.

The server 201 stores the initial operating node count N and the redundant node count α (step S1401). The server 201 determines whether the malfunctioning node count Ex and a malfunction time tx have been detected (step S1402). An example of detection may be the server 201 receiving notification from one of the plural nodes #1 to N by the operation at step S1306 and at a certain time point, detecting the malfunctioning node count Ex and the malfunction time tx. Further, the server 201 may receive from the aggregating apparatus AG, a count of nodes that are not malfunctioning at a certain time point and when the received count and the previously received count differs, the server may detect the malfunctioning node count Ex and the malfunction time tx.

If the malfunctioning node count Ex and the malfunction time tx have not been detected (step S1402: NO), the server 201 transitions to the operation at step S1402. If the malfunctioning node count Ex and the malfunction time tx have been detected (step S1402: YES), the server 201 uses past malfunctioning node counts and time points, Ex, and tx to generate the deterioration approximating function E=f(t) (step S1403). The server 201 calculates N′=N+α−f(tx+Δt) (step S1404).

The server 201 determines if N′ is the function maintaining threshold or greater (step S1405). If N′ is the function maintaining threshold or greater (step S1405: YES), the server 201 transitions to the operation at step S1402.

If N′ is less than the function maintaining threshold (step S1405: NO), the server 201 uses N′ and the function maintaining threshold to calculate an additional node count Na when individually inspected nodes are to be added (step S1406). The server 201 calculates the cost Co_a=Ca×Na (step S1407). The server 201 uses N′ and the function maintaining threshold to calculate an additional node count Np when sampling inspected nodes are to be added (step S1408). The server 201 calculates the cost Co_p=Cp×Np (step S1409).

The server 201 outputs the smaller value of Co_a and Co_p as the nodes to be added (step S1410). The server 201 determines whether nodes have been additionally dispersed by the operator (step S1411). If additional node dispersion by the operator has not been input (step S1411: NO), the server 201 transitions to step S1402.

If additional node dispersion by the operator has been input (step S1411: YES), the server 201 sends to the aggregating apparatus AG, notification of the additional node dispersion (step S1412). After the operation at step S1412, the server 201 transitions to the operation at step S1402.

As described, according to the server 201, from the number of nodes malfunctioning in a period during operation of the sensor network system 200, the number of nodes that malfunction per unit time after the period are calculated. Thus, the server 201 enables the timing when failure of the sensor network system 200 will occur to be predicted.

Further, according to the server 201, based on the number of nodes that malfunction per unit time and the number of nodes not malfunctioning among the plural nodes at the end time of a period, the number of nodes not malfunctioning at a time point after the period may be calculated. As a result, the operator can view the number of nodes that are not malfunctioning for the time point to determine whether additional nodes are to be dispersed. For example, if the number of nodes not malfunctioning at the time point is less than expected, the operator may determine that additional nodes are to be dispersed even when the number is greater than the function maintaining threshold.

According to the server 201, whether the number of nodes not malfunctioning at a time point is less than the function maintaining threshold may be determined based on the number of nodes that malfunction per unit time and the number of nodes not malfunctioning at the end time of a period. Thus, the operator can view the determination result to determine whether additional nodes are to be dispersed. For example, the operator may determine that additional nodes are to be dispersed when the number of nodes not malfunctioning at a time point is less than the function maintaining threshold.

Further, according to the server 201, based on the number of nodes not malfunctioning at a time point and the function maintaining threshold, the number of nodes to be added to the sensor network system 200 by the time point may be detected. Thus, the operator can view the additional node count to determine the number of nodes to be added. For example, the operator is assumed to manage undispensed nodes of a certain lot in small units of 12[nodes]. The server 201 is assumed to output that the additional node count is 20[nodes]. In this case, the operator sets the number of nodes to be added as 12×2=24[nodes].

Further, according to the server 201, the additional node count may be calculated based on the node acceptable product ratio, the number of nodes not malfunctioning at a time point, and the function maintaining threshold. Thus, the operator can know a proper additional node count even when high-volume production, low-cost nodes are to be added.

According to the server 201, the additional node count is calculated according to lot, and based on the unit node price according to lot and the calculated additional node count, the cost of adding nodes to the sensor network system 200 can be calculated for each lot. Thus, when there are plural nodes for which the acceptable product ratio differs, the operator can choose as the nodes to be added, nodes having a lower cost. In the first embodiment, although there are two types of nodes (individually inspected nodes and sampling inspected nodes) for which the acceptable product ratio differs, there may be three or more types. For example, the manufacturer is assumed offer intermediate-quality, intermediate unit priced nodes for which the number of samples to be inspected from a lot is increased at the sampling inspection stage, and low-quality, low unit priced nodes for which the number of samples to be inspected from a lot is decreased at the sampling inspection stage. In this case, the server 201 may calculate the cost for individually inspected nodes, sampling inspection for an intermediate unit price and intermediate acceptable product ratio, and sampling inspection for a low unit price and low acceptable product ratio.

According to the server 201, the difference of the number of nodes capable of communication at the start time of a period among plural nodes and the number of nodes capable of communication at the end time of the period may be calculated as the number of nodes that are malfunctioning. Thus, the server 201 can obtain malfunctioning nodes.

In the sensor network system 200 according to the first embodiment, the number of nodes not malfunctioning at a time point after a period and the function maintaining threshold are compared to determine, without using position information of the plural nodes #1 to N, whether function can be maintained. Nonetheless, even when the number of nodes not malfunctioning at a time point is less than the function maintaining threshold, function may be maintained depending on the position of a node that is not malfunctioning. Therefore, in a sensor network system, according to the second embodiment, position information of the plural nodes #1 to N is used to simulate whether function can be maintained. Portions identical to those described in the first embodiment are given the same reference numerals used in the first embodiment and will not be redundantly described.

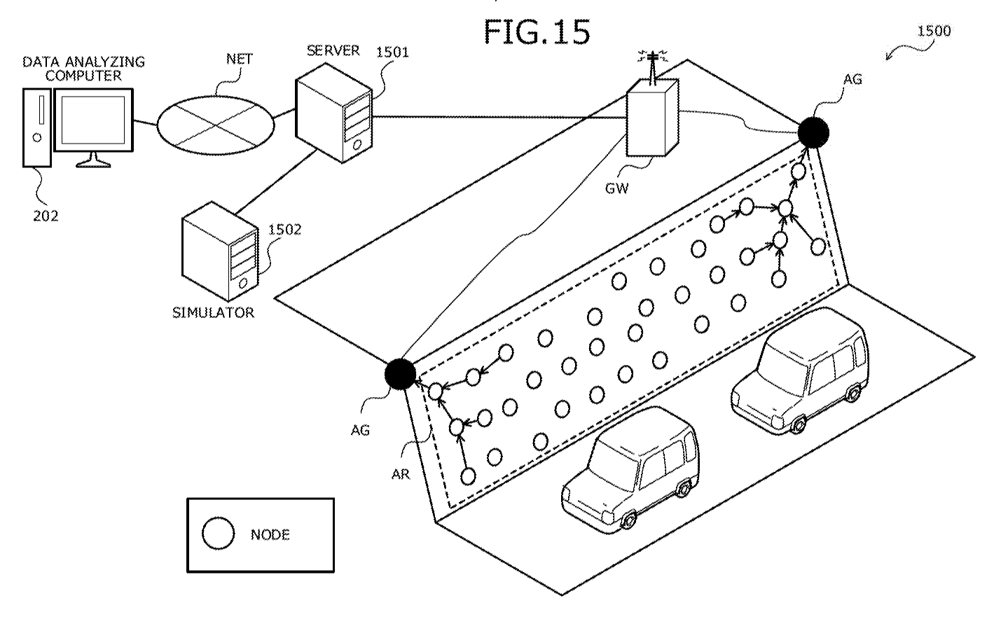

FIG. 15 is a diagram depicting an example of connection of the sensor network system according to the second embodiment. A sensor network system 1500 according to the second embodiment includes the plural nodes, the aggregating apparatus AG, the gateway GW, a server 1501, the data analyzing computer 202, and a simulator 1502.

The server 1501 has a function of the server 201 and further notifies the simulator 1502 of position information of nodes that are not malfunctioning at the end time of a period and the number of nodes not malfunctioning at a time point after the period. Alternatively, the server 1501 may notify the simulator 1502 of the number of nodes that malfunction at a time point instead of the number of nodes not malfunctioning at a time point. Thereafter, the server 1501 receives from the simulator 1502, a simulation result and outputs the simulation result to the operator of the sensor network system 1500.

The simulator 1502 is a computer configured to use the position information of the nodes that are not malfunctioning at the end time of the period and the number of nodes that are not malfunctioning at the time point after the period to simulate multihop communication of the nodes at the time point. The server 1501 may execute the function performed by the simulator 1502. Hardware configuration of the simulator 1502 is identical to the hardware of the server 1501 and therefore, description thereof is omitted herein.

Further, in the second embodiment, position information of the respective nodes among the plural nodes #1 to N is used. To obtain position information of the nodes, for example, a portion of the nodes may have a global positing system (GPS) sensor, whereby position information is obtained by the GPS sensor. A node without a GPS function may calculate position information for the node based on the position information of a node having a GPS sensor and the distance to the node having the GPS sensor.

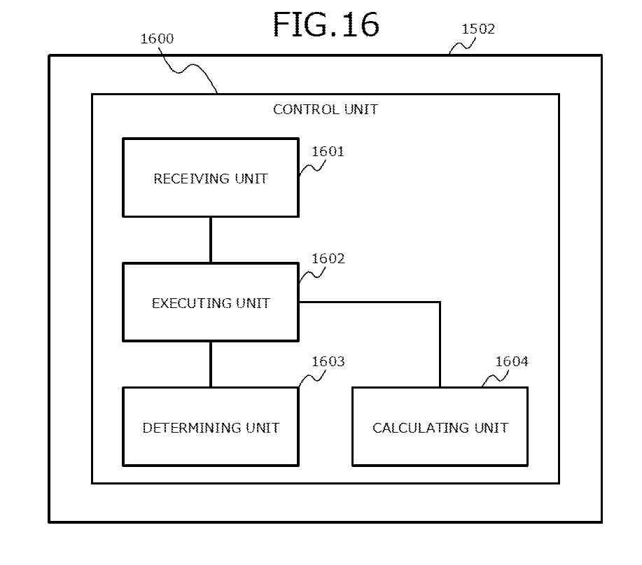

FIG. 16 is a block diagram of an example of a functional configuration of the simulator. The simulator 1502 includes a control unit 1600. The control unit 1600 includes a receiving unit 1601, an executing unit 1602, a determining unit 1603, and a calculating unit 1604. A function of the control unit 1600 is implemented by executing on the CPU of the simulator 1502, an analysis program of the second embodiment, stored in a storage apparatus. The storage apparatus, for example, is ROM, RAM, a disk, or the like of the simulator 1502. Processing results of the receiving unit 1601 to the calculating unit 1604 are stored to a register, RAM, or the like of the CPU of the simulator 1502.

The receiving unit 1601 receives position information of nodes that among the plural nodes #1 to N, are not malfunctioning at the end time of a period.

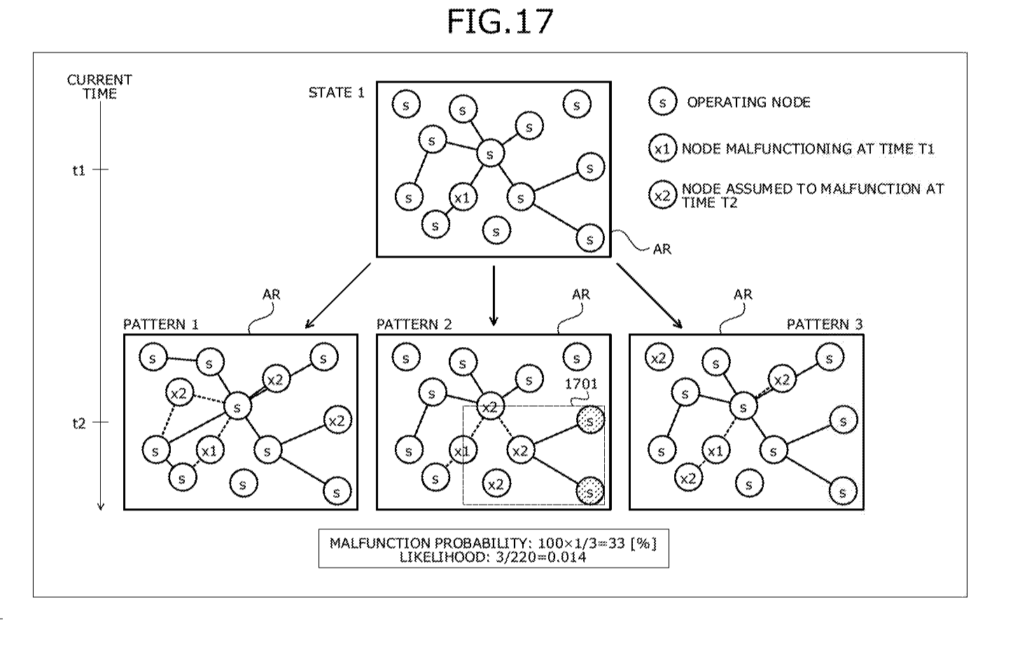

The executing unit 1602 randomly sets among the nodes that are not malfunctioning at the end time, nodes not malfunctioning at a time point, corresponding to the calculated number of nodes not malfunctioning at the time point. When nodes that are not malfunctioning are randomly set, the executing unit 1602 executes simulation of multihop communication by the nodes not malfunctioning at the time point, based on the position information of the nodes not malfunctioning and received by the receiving unit 1601. Alternatively, the executing unit 1602 may randomly set nodes that malfunction to execute simulation. FIGS. 17 to 21 depict an example of simulation.

The executing unit 1602 may randomly set nodes that are not malfunctioning at the time point and execute simulation for a predetermined number of executions. Here, the predetermined number of executions is a value set by the operator of the sensor network system 1500. For example, the operator obtains, in advance, the amount of time consumed for one execution of the simulation. The operator divides the simulation time by the time consumed for one execution of the simulation and sets the obtained value as the predetermined number of executions.

The determining unit 1603 determines whether function can be realized, by comparing the function maintaining threshold and the number of nodes capable of communication, obtained from an execution result of the simulation by the executing unit 1602.

Alternatively, the determining unit 1603 determines whether function can be realized, by comparing for each execution result of the simulation executed for the predetermined number of executions by the executing unit 1602, the function maintaining threshold, and the number of nodes capable of communication, obtained from the execution result. For example, the determining unit 1603 outputs the number of times that the determining unit 1603 determines that function can be maintained and the number of times that the determining unit 1603 determines that function cannot be maintained.

The calculating unit 1604 calculates a likelihood indicating the plausibility of the determination result of the determining unit 1603, based on the predetermined number of executions and the total number of combinations possible when setting nodes that are not malfunctioning at the time point, among the nodes not malfunctioning at the end time. For example, the calculating unit 1604 calculates predetermined number of executions/(total combinations) as the likelihood, where the greater the value is, the more plausible the likelihood is. The calculating unit 1604 may calculate (total combinations)/predetermined number of executions, where the smaller the value is, the more plausible the likelihood is. Likelihood will be described with reference to FIG. 17.

FIG. 17 is a diagram depicting an example of simulation in a case where nodes that malfunction are randomly changed. FIG. 17 depicts results of simulation performed for patterns 1 to 3 by the simulator 1502, when among twelve nodes that are operating, three nodes are predicted to malfunction at time t2 subsequent to time t1 (current time). In FIG. 17, a white circle having an “s” represents an operating node. A white circle having “x1” represents a node that is malfunctioning at time t1,which is the current time. A white circle having “x2” represents a node assumed to malfunction at time t2 after time t1.

In the simulation of patterns 1 and 3, the simulator 1502 determines that sufficient measurement can be continued to maintain functioning by reconnecting the nodes. The determination criteria here are assumed to be defined and to be dependent on the sensing field AR that assumes a measurement density index, and a point targeted for measurement.

In contrast, in the simulation of pattern 2, the simulator 1502 determines that in an area 1701, which is a southeastern portion of the sensing field AR, sufficient measurement cannot be achieved to enable functioning to be maintained.

The server 1501 obtains the results of simulation of each pattern by the simulator 1502 and calculates a malfunction probability using equation (4).

malfunction probability=100×m/n[%] (4)

Where, m is the number of times that the simulator 1502 determines that function can be maintained, and n is the number of times that simulation is performed. The server 1501 further uses equation (5) to calculate a likelihood that indicates the plausibility of the calculated malfunction probability.

likelihood=n/C (5)

Where, C is the total possible combinations of nodes that malfunction. In the example depicted in FIG. 17, the server 1501 uses equation (4) and calculates the malfunction probability as indicated below.

malfunction probability=100×1/3=33[%]

The server 1501 further uses equation (5) to calculate the likelihood in the example depicted in FIG. 17. The total combinations C of nodes that malfunction is ₁₅C₃=220.

likelihood=3/220=0.014

The operator of the sensor network system 1500 views the malfunction probability and determines whether nodes are to be additionally dispersed. The operator of the sensor network system 1500 views the likelihood and determines whether the malfunction probability is a credible value. For example, when determining that, the likelihood is too low, the operator of the sensor network system 1500 operates the server 1501 to cause the simulator 1502 to again execute the simulation.

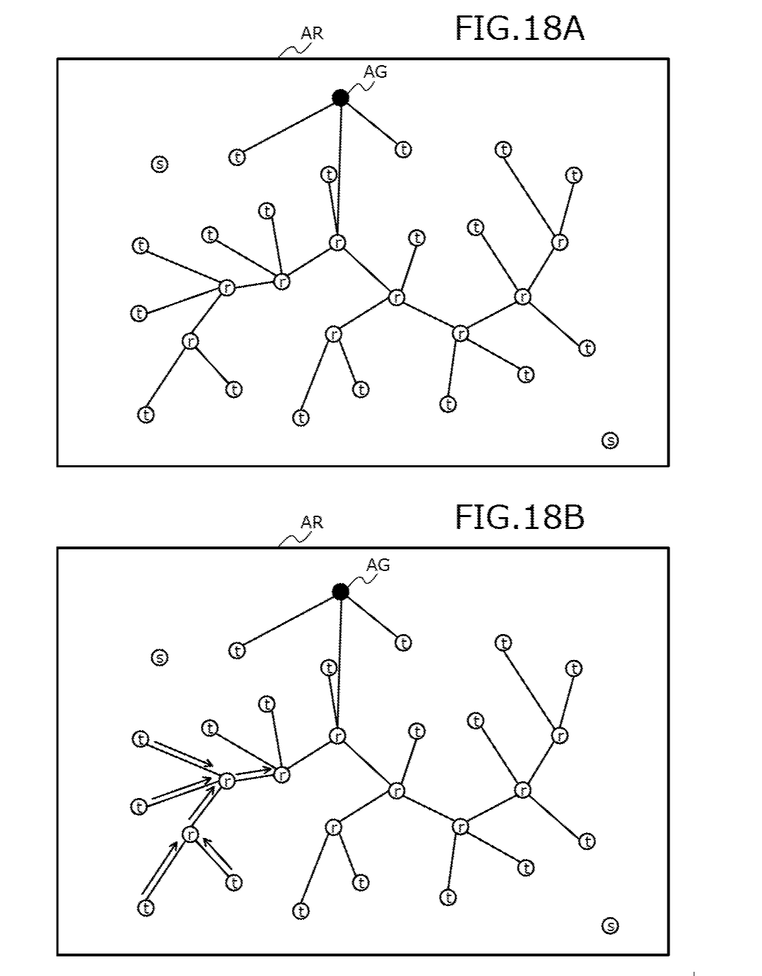

Simulation performed by the simulator 1502 to simulate communication paths built by the nodes will be described with reference to FIGS. 18(A) to 21. In FIGS. 18(A) to 21, a white circle having a “t” represents a terminal node that does not relay data and that is an operating node. A white circle with an “r” represents a node that relays data and that is an operating node. A white circle havinq an “s” represents a node that is suspending communication with nearby nodes and is a backup node. A white circle having an “x” represents a malfunctioning node.

FIGS. 18(A) and 18(B) are diagrams of an example of changing a communication path built by the nodes (part 1). FIG. 18(A) depicts node communication paths in a state where no malfunctioning nodes are present. FIG. 18(B) depicts data aggregation to the aggregating apparatus AG, in the node communication paths in the state where no malfunctioning nodes are present.

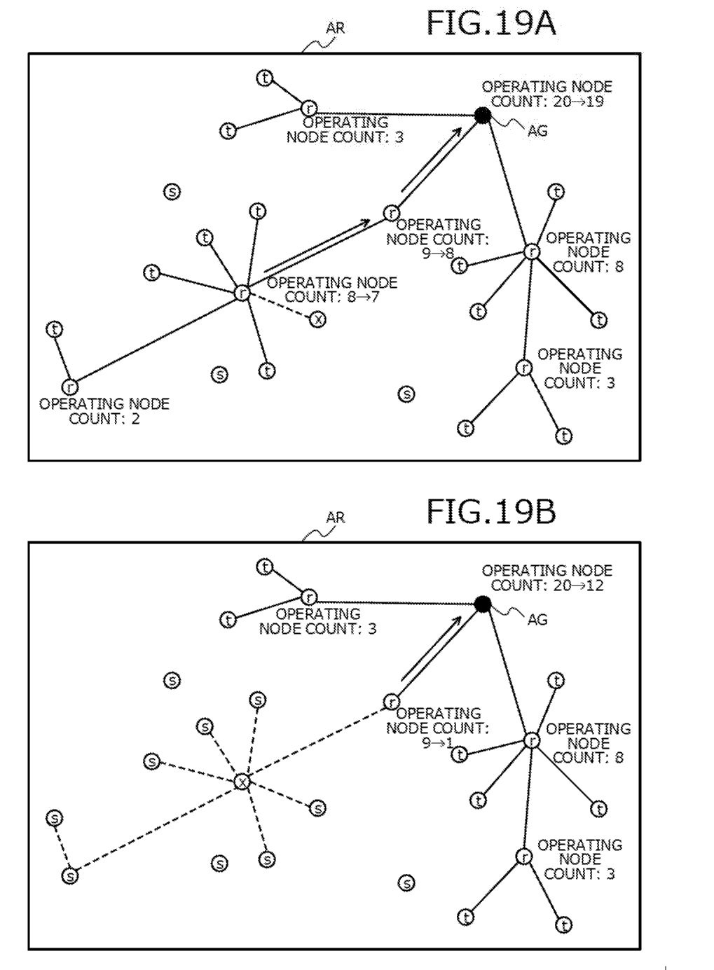

FIGS. 19(A) and 19(B) are diagrams of an example of changing a communication path built by nodes (part 2). FIG. 19(A) depicts a case where one terminal node malfunctions. In FIG. 19(A), the operating node count decreases from 20 to 19. In contrast, FIG. 19(B) depicts a case where one relay node malfunctions. In FIG. 19(B), the operating node count decreases from 20 to 12. In this manner, the operating node count in a case where a relay node malfunctions decreases by a greater amount than the operating node count in a case where a terminal node malfunctions, and has a possibility of dropping below the function maintaining threshold. In such cases, the aggregating apparatus AG and the server 1501 instruct the nodes to rebuilt communication paths and therefore, the simulator 1502 simulates rebuilding of the communication paths.

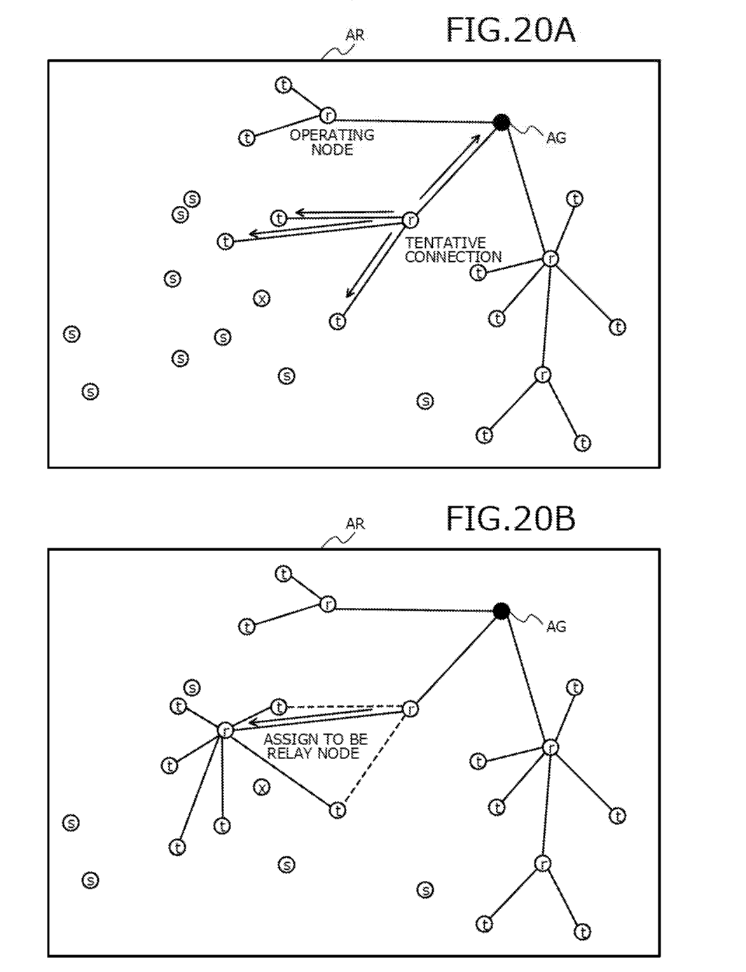

FIGS. 20(A) and 20(B) are diagrams of an example of changing a communication path built by nodes (part 3). FIG. 20(A) depicts a state of nodes transmitting to nearby nodes, communication path connection requests and performing tentative connection. FIG. 20(B) depicts a terminal node being assigned as a relay node.

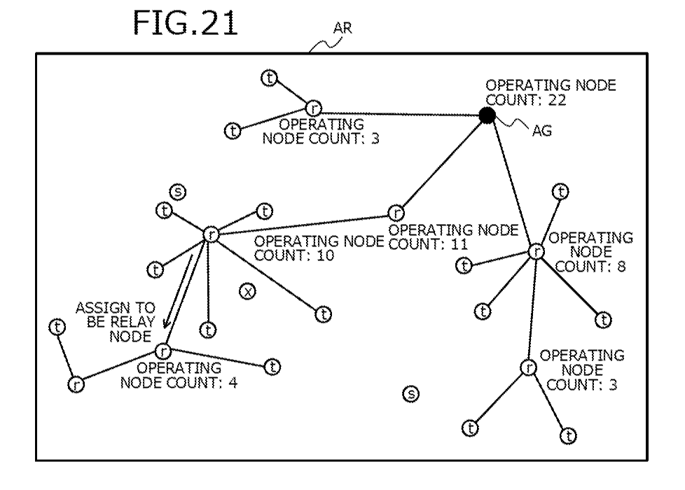

FIG. 21 is a diagram of an example of changing a communication path built by nodes (part 4). FIG. 21 depicts a state after relay nodes are assigned and communication paths are rebuilt. In this manner, in the sensor network system 1500, even when a relay node malfunctions, by assigning a terminal node as a relay node, a decrease in the operating nodes can be suppressed. As depicted in FIGS. 18(A) to 21, when a relay node is assumed to malfunction, the simulator 1502 rebuilds communication paths, makes a comparison with the function maintaining threshold, and determines whether function can be maintained.

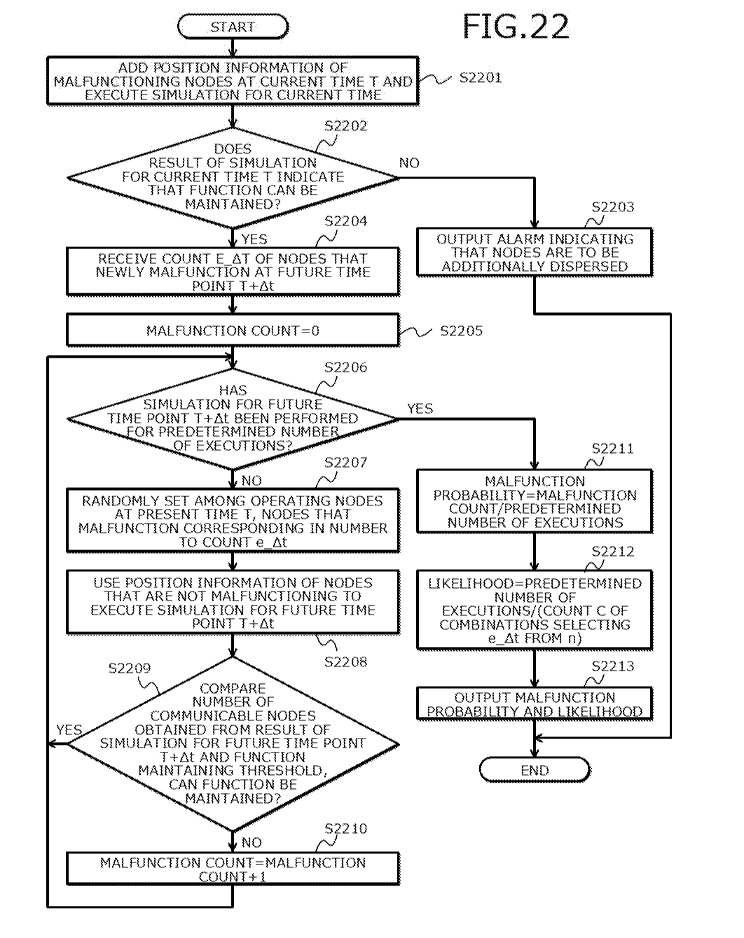

FIG. 22 is a flowchart of an example of a procedure of a function maintenance index output process. The function maintenance index output process is a process of executing a simulation process of simulating muitihop communication of the nodes and outputting an index value of whether function can be maintained. The simulator 1502 adds position information of malfunctioning nodes at the current time T and executes simulation for the current time T (step S2201).

The simulator 1502 determines whether the result of simulation for the current time T indicates that function can be maintained (step S2202). If function cannot be maintained (step S2202: NO), the simulator 1502 outputs an alarm indicating that nodes are to be additionally dispersed (step S2203). The output destination of the alarm is the server 1501. The server 1501 having received the alarm, outputs contents of the alarm by a method that enables the operator of the sensor network system 1500 to view the contents. After the operation at step S2203, the simulator 1502 terminates the function maintenance index output process.

If function can be maintained (step S2202: YES), the simulator 1502 receives from the server 1501, a count e_Δt of nodes that newly malfunction at a future time point T+Δt (step S2204). The simulator 1502 sets a malfunction count to 0 (step S2205). The simulator 1502 determines whether simulation for the future time point T+Δt has been performed for the predetermined number of executions (step S2206). If the simulation has not been performed for the predetermined number of executions (S2206: NO), the simulator 1502 randomly sets among the operating nodes at the present time T, nodes that malfunction corresponding in number to the count e_Δt (step S2207).

The simulator 1502 uses the position information of the nodes that are not malfunctioning to execute the simulation for the future time point T+Δt (step S2208). The simulator 1502 compares the number of communicable nodes obtained from the result of the simulation for the future time point T+AΔt and the function maintaining threshold, and determines whether function can be maintained (step S2209). If function cannot be maintained (step S2209: NO), the simulator 1502 increments the malfunction count (step S2210). After the operation at step S2210, or if function can be maintained (step S2209: YES), the simulator 1502 transitions to the operation at step S2206.

If the simulation has been performed for the predetermined number of executions (step S2206: YES), the simulator 1502 calculates the malfunction probability=malfunction count/predetermined number of executions (step S2211). The simulator 1502 calculates the 1ikelihood=predetermined number of executions/(count C of combinations selecting e_Δt from n) (step S2212). The simulator 1502 outputs the malfunction probability and the likelihood (step S2213). The output destination of the malfunction probability and the likelihood is the server 1501. The server 1501 having received the malfunction probability and the likelihood, outputs the malfunction probability and the likelihood by a method that enables the operator of the sensor network system 1500 to view the malfunction probability and the likelihood. After the operation at step S2213, the simulator 1502 terminates the function maintenance index output process.

By executing the function maintenance index output process, the sensor network system 1500 is able to provide to the operator, a malfunction probability and likelihood, which are index values of whether function can be maintained and are used in determining whether nodes are to be additionally dispersed.

As described, according to the simulator 1502, among nodes not malfunctioning at an end time, nodes not malfunctioning at a time point targeted for calculation are randomly set corresponding in number to the number of nodes not malfunctioning at the time point. The simulator 1502 may execute simulation for the time point, based on the position information of nodes not malfunctioning at the end time and from execution results of the simulation; and output whether function can be maintained. As a result, the operator can determine that nodes are not to be additionally dispersed if the possibility of function being maintained is high even when the number of nodes not malfunctioning at time point after the current time is less than the function maintaining threshold.

According to the simulator 1502, nodes not malfunctioning may be set randomly for a time point, simulation may be performed for a predetermined number of executions, and the number of determinations that function can be maintained and the number of determinations that function cannot be maintained may be output. As a result, the operator can view the number of determinations that function can be maintained and the number of determinations that function cannot be maintained, and determine whether nodes are to be additionally dispersed.

According to the simulator 1502, likelihood may be calculated, based on the predetermined number of executions and the total possible combinations of nodes when nodes not malfunctioning are set randomly from nodes not malfunctioning at an end time. As a result, the operator can determine whether the number of determinations that function can be maintained and the number of determinations that function cannot be maintained is reliable. For example, even when the number of determinations that function can be maintained is greater than the number of determinations that function cannot be maintained, if the likelihood indicates implausibility, the operator may increase the predetermined number of executions and cause the simulator 1502 to execute the simulation, or may determine that nodes are to be added.

The analysis method described in the first and second embodiments may be implemented by executing a prepared program on a computer such as a personal computer, a work station, and the like. The analysis program is stored to a computer-readable recording medium such as a hard disk, a flexible disk, CD-ROM, MO, DVD, and the like, and is read out and executed by a computer. Further, the analysis program may be distributed through a network such as the Internet.

According to one aspect of the present invention, an effect is achieved in that the timing when a failure in a system occurs can be predicted.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An analysis method comprising:
detecting, by a computer, a malfunctioning node count of nodes malfunctioning among a plurality of nodes in a period during operation of a system configured to realize a function even when a portion of nodes malfunction among the plurality of nodes; and
calculating, by the computer and based on the detected malfunctioning node count and the period, a count of nodes that malfunction per unit time after the period.

2.The analysis method according to claim 1, further comprising
calculating, by the computer, a count of nodes not malfunctioning at a time point after the period, based on the calculated count of nodes that malfunction per unit time and a count of nodes not malfunctioning at an end time of the period among the plurality of nodes.

3. The analysis method according to claim 1, further comprising
determining, by the computer and based on the count of nodes that malfunction per unit time and a count of nodes not malfunctioning at an end time of the period among the plurality of nodes, whether a count of nodes not malfunctioning at a time point after the period is less than a predetermined node count that is pre-stored and enables the function to be realized.

4. The analysis method according to claim 3, further comprising
calculating, by the computer, an additional node count of nodes to be added to the system before the time point, when the count of nodes not malfunctioning at the time point is determined to be less than the predetermined node count, the additional node count being calculated based on the predetermined node count and the count of nodes not malfunctioning at the time point.

5. The analysis method according to claim 4, wherein
the additional node count is calculated based on a node acceptable product ratio that is pre-stored, the count of nodes not malfunctioning at the time point, and the predetermined node count.

6. The analysis method according to claim 4, wherein
the additional node count is calculated according to lot and is calculated based on a node acceptable product ratio that is pre-stored and lot specific, the count of nodes not malfunctioning at the time point, and the predetermined node count, a lot being a manufacturing unit of node manufacturing, and
the analysis method further comprises:
calculating, by the computer and according to lot, a cost for adding to the system, nodes of the calculated additional node count, the cost being calculated based on a node unit price that is pre-stored and lot specific, and the calculated additional node count.

7. The analysis method according to claim 2, further comprising:
receiving, by the computer, position information of nodes not malfunctioning at the end time, among the plurality of nodes;
executing, by the computer and based on the received position information, simulation of multihop communication by nodes not malfunctioning at the time point, the simulation being executed for a case when among nodes not malfunctioning at the end time, the nodes not malfunctioning at the time point are set randomly corresponding in number to the calculated count of nodes not malfunctioning at the time point.

8. The analysis method according to claim 7, wherein
the simulation is executed for a predetermined number of executions and by randomly setting the nodes not malfunctioning at the time point, and
the analysis method further comprises:
determining, by the computer, whether the function can be realized, by comparing for each execution result of the simulation executed for the predetermined number of executions, a communicable node count obtained from the execution result and the predetermined node count.

9. The analysis method according to claim 8, further comprising
calculating, by the computer, a likelihood that indicates plausibility of a result of determining whether the function can be realized, the likelihood being calculated based on the predetermined number of executions and total possible combinations obtained when the nodes not malfunctioning at the time point are set randomly from the nodes not malfunctioning at the end time.

10. The analysis method according to claim 1, wherein
a difference of a communicable node count of the plurality of nodes at a start time of the period and a communicable node count at an end time of the period is detected as the malfunctioning node count.

11. A non-transitory, computer-readable recording medium storing therein an analysis program causing a computer to execute a process comprising:
detecting a malfunctioning node count of nodes malfunctioning among a plurality of nodes in a period during operation of a system configured to realize a function even when a portion of nodes malfunction among the plurality of nodes; and
calculating based on the detected malfunctioning node count and the period, a count of nodes that malfunction per unit time after the period.

12. An analysis apparatus comprising:
a control circuit configured to detect a malfunctioning node count of nodes malfunctioning among a plurality of nodes in a period during operation of a system configured to realize a function even when a portion of nodes malfunction among the plurality of nodes; and calculate based on the detected malfunctioning node count and the period, a count of nodes that malfunction per unit time after the period.
